(19) United States
(12) Patent Application Publication
(10) Pub. No.: US 2025/0036236 A1
(43) Pub. Date: Jan. 30, 2025

(54) ELECTRONIC DEVICE

(71) Applicant: SAMSUNG DISPLAY CO., LTD., YONGIN-SI (KR)

(72) Inventors: KYOWON KU, Yongin-si (KR); SANGHYUN LIM, Yongin-si (KR)

(21) Appl. No.: 18/743,227

(22) Filed: Jun. 14, 2024

(30) Foreign Application Priority Data
Jul. 27, 2023 (KR) 10-2023-0097963

(51) Int. Cl. G06F 3/041; G06F 3/044

(52) U.S. Cl. CPC G06F 3/041662; G06F 3/04164; G06F 3/0442; G06F 3/0443; G06F 3/0446; G06F 2203/04102

(57) ABSTRACT

An electronic device including: a sensor layer; and a sensor driver to operate in a first mode for sensing a touch input or in a second mode for sensing a pen input, the sensor layer including: first electrodes arranged along a first direction and extending along a second direction; second electrodes arranged along the second direction and extending along the first direction; third electrodes arranged along the first direction and extending along the second direction; a fourth electrode arranged along the second direction, extending along the first direction, and including sub-electrodes; first trace lines connected to the first electrodes; second trace lines connected to the second electrodes; a third trace line connected to the third electrodes; and a fourth trace line connected to the fourth electrode and connected to an end of each of the sub-electrodes.

### CROSS-REFERENCE TO RELATED APPLICATION

This application claims priority under 35 U.S.C. § 119 to Korean Patent Application No. 10-2023-0097963 filed on Jul. 27, 2023, in the Korean Intellectual Property Office, the disclosure of which is incorporated by reference herein in its entirety.

### TECHNICAL FIELD

Embodiments of the present disclosure described herein relate to an electronic device that senses an input by a pen.

### DISCUSSION OF RELATED ART

Multimedia electronic devices, including televisions, mobile phones, tablet computers, navigation systems, and game consoles, are commonly equipped with display devices for image presentation. These devices often feature a sensor layer or an input sensor, providing a touch-based input method. This scheme allows users to input information or commands easily, intuitively, and conveniently, in addition to traditional input schemes such as buttons, keyboards, and mice. The sensor layer is designed to detect touch or pressure applied by a user's body. There is a growing demand for the use of a pen, especially for users accustomed to writing instruments or for a specific application, such as sketching or drawing, where delicate touch input is employed.

### SUMMARY

Embodiments of the present disclosure provide an electronic device that senses an input by a pen.

An embodiment of the present disclosure provides an electronic device including: a sensor layer; and a sensor driver configured to operate the sensor layer, wherein the sensor driver is further configured to operate in a first mode for sensing a touch input or in a second mode for sensing a pen input, wherein the sensor layer includes: a plurality of first electrodes arranged along a first direction and extending along a second direction intersecting the first direction; a plurality of second electrodes arranged along the second direction and extending along the first direction; a plurality of third electrodes arranged along the first direction and extending along the second direction; a fourth electrode arranged along the second direction, extending along the first direction, and including a plurality of sub-electrodes electrically connected with each other; a plurality of first trace lines electrically connected to the plurality of first electrodes, respectively; a plurality of second trace lines electrically connected to the plurality of second electrodes, respectively; a third trace line electrically connected to the plurality of third electrodes; and a fourth trace line electrically connected to the fourth electrode and connected to an end of each of the plurality of sub-electrodes, wherein the sensor driver is configured to output a driving signal to the third trace line and the fourth trace line in the first mode.

The first mode includes a mutual-capacitance detection mode and a self-capacitance detection mode, wherein the sensor driver is configured to output the driving signal to the plurality of first electrodes and the plurality of second electrodes in the self-capacitance detection mode.

The self-capacitance detection mode includes a first time period and a second time period, wherein the sensor driver is configured to: output the driving signal to the plurality of first trace lines in the first time period; and output the driving signal to the plurality of second trace lines, the third trace line, and the fourth trace line in the second time period.

The plurality of third electrodes and the fourth electrode are grounded in the mutual-capacitance detection mode.

The driving signal is provided to the plurality of third electrodes and the fourth electrode in the self-capacitance detection mode.

The plurality of third electrodes and the fourth electrode are electrically separated from the plurality of third trace lines and the fourth trace line in the self-capacitance detection mode.

The electronic device further includes a switch connected between the fourth electrode and the fourth trace line, wherein the switch is turned off in the first mode and is turned on in the second mode.

The electronic device further includes a plurality of switches connected between the plurality of sub-electrodes, wherein the plurality of switches are turned off in the first mode and are turned on in the second mode.

The third trace line includes a first portion extending along the first direction and electrically connected to the plurality of third electrodes, a second portion extending along the second direction from a first end of the first portion, and a third portion extending along the second direction from a second end of the first portion.

The electronic device further includes a plurality of switches connected between the first portion and the second portion and between the first portion and the third portion, respectively, wherein the plurality of switches are turned off in the first mode and turned on in the second mode.

The sensor layer further includes a plurality of fifth trace lines electrically connected to the plurality of third electrodes, respectively.

The electronic device further includes a plurality of switches connected between the plurality of fifth trace lines and the plurality of third electrodes, respectively, wherein the plurality of switches are turned off in the first mode and are turned on in the second mode.

The second mode includes a charging section and a pen sensing section, wherein the plurality of first electrodes, the plurality of second electrodes, and the fourth electrode are grounded in the charging section, wherein, in the pen sensing section, the plurality of third electrodes and the fourth electrode are grounded, and the sensor driver is configured to detect coordinates for the pen input based on a current provided from the plurality of first electrodes and the plurality of second electrodes.

An embodiment of the present disclosure provides an electronic device including: a sensor layer including a plurality of first electrodes, a plurality of second electrodes, a plurality of third electrodes, a fourth electrode, and a plurality of trace lines; and a sensor driver configured to operate the sensor layer, wherein the sensor driver is further configured to operate in a mutual-capacitance detection mode, a self-capacitance detection mode, or a pen sensing mode including a charging time period and a pen sensing time period, wherein the sensor driver is configured to, in the self-capacitance detection mode, output a driving signal to the plurality of first electrodes and the plurality of second electrodes, and calculate input coordinates by sensing a change in capacitance of each of the plurality of first electrodes and the plurality of second electrodes, wherein the sensor driver is configured to output the driving signal to at least some of the trace lines connected to the plurality of third electrodes and the fourth electrode in the self-capacitance detection mode.

The fourth electrode includes a plurality of sub-electrodes electrically connected each other, wherein the plurality of trace lines include: a plurality of first trace lines electrically connected to the plurality of first electrodes, respectively; a plurality of second trace lines electrically connected to the plurality of second electrodes, respectively; a third trace line connected to a first end of each of the plurality of third electrodes; a fourth trace line electrically connected to the fourth electrode and connected to an end of each of the plurality of sub-electrodes; and a plurality of fifth trace lines connected to second ends of the plurality of third electrodes, respectively, wherein the sensor driver is configured to output the driving signal to the third trace line and the fourth trace line in the self-capacitance detection mode.

The driving signal is provided to the plurality of third electrodes and the fourth electrode in the self-capacitance detection mode.

The plurality of third electrodes and the fourth electrode are electrically separated from the plurality of third trace lines and the fourth trace line in the self-capacitance detection mode.

The sensor driver is configured to, in the charging section, apply a current to one of a plurality of pads connected to the third trace line and the plurality of fifth trace lines and to receive current via another pad, and wherein the plurality of first electrodes, the plurality of second electrodes, and the fourth electrode are grounded in the charging section, wherein the sensor driver is configured to detect coordinates for a pen input based on a current provided from the plurality of first electrodes and the plurality of second electrodes in the pen sensing section, and wherein the plurality of third electrodes and the fourth electrode are grounded in the pen sensing section.

The sensor driver is configured to, in the mutual-capacitance detection mode, output a transmission signal to the plurality of first electrodes, receive a reception signal from the plurality of second electrodes, and calculate input coordinates by sensing a change in mutual capacitance between the plurality of first electrodes and the plurality of second electrodes, wherein the plurality of third electrodes and the fourth electrode are grounded in the mutual-capacitance detection mode.

An embodiment of the present disclosure provides an electronic device including: a sensor layer including a plurality of first electrodes arranged along a first direction and extending along a second direction intersecting the first direction, a plurality of second electrodes arranged along the second direction and extending along the first direction, a plurality of third electrodes arranged along the first direction and extending along the second direction, a fourth electrode arranged along the second direction, extending along the first direction, and including a plurality of sub-electrodes connected in parallel with each other, a plurality of first trace lines electrically connected to the plurality of first electrodes, respectively, a plurality of second trace lines electrically connected to the plurality of second electrodes, respectively, a third trace line electrically connected to a first end of each of the plurality of third electrodes, a fourth trace line electrically connected to the fourth electrode and connected to the end of each of the plurality of sub-electrodes, and a plurality of fifth trace lines connected to second ends of the plurality of third electrodes, respectively; and a sensor driver configured to drive the sensor layer, and operate in a pen sensing mode for sensing a pen input or in a touch sensing mode for sensing a touch input, wherein, in the pen sensing mode, the sensor driver is configured to apply a current to one of a plurality of pads connected to the third trace line and the plurality of fifth trace lines, receive current via another pad, and detect coordinates for the pen input based on a current provided from the plurality of first electrodes and the plurality of second electrodes, wherein the sensor driver is configured to output a driving signal to the plurality of first electrodes and the plurality of second electrodes in the touch sensing mode, and calculate input coordinates by sensing a change in capacitance of each of the plurality of first electrodes and the plurality of second electrodes, wherein the sensor driver is configured to output the driving signal to the plurality of first electrodes and the plurality of second electrodes in the touch sensing mode, calculate input coordinates by sensing a change in capacitance of each of the plurality of first electrodes and the plurality of second electrodes, and output the driving signal to at least some of the third trace line, the fourth trace line, and the plurality of fifth trace lines in the touch sensing mode.

The driving signal is provided to the plurality of third electrodes and the fourth electrode in the touch sensing mode.

The plurality of third electrodes and the fourth electrode are electrically separated from at least some of the plurality of third trace lines, the fourth trace line, and the plurality of fifth trace lines in the touch sensing mode, and are not provided with the driving signal.

### BRIEF DESCRIPTION OF THE DRAWINGS

The above and other features of the present disclosure will become apparent by describing in detail embodiments thereof with reference to the accompanying drawings.

FIG. 1 is a perspective view of an electronic device according to an embodiment of the present disclosure.

FIG. 2 is a perspective view of an electronic device according to an embodiment of the present disclosure.

FIG. 3 is a cross-sectional view of an electronic device according to an embodiment of the present disclosure.

FIG. 4 is a diagram illustrating an operation of an electronic device according to an embodiment of the present disclosure.

FIG. 5 is a cross-sectional view of an electronic device according to an embodiment of the present disclosure.

FIG. 6 is a plan view of a sensor layer according to an embodiment of the present disclosure.

FIG. 7 is an enlarged plan view of a sensing unit according to an embodiment of the present disclosure.

FIG. 8A is a plan view showing a first conductive layer of a sensing unit according to an embodiment of the present disclosure.

FIG. 8B is a plan view showing a second conductive layer of a sensing unit according to an embodiment of the present disclosure.

FIG. 9 is a cross-sectional view of a sensor layer according to an embodiment of the present disclosure taken along line I-I′ shown in each of FIGS. 8A and 8B.

FIG. 10A is an enlarged plan view of area AA′ shown in FIG. 8A.

FIG. 10B is an enlarged plan view of area BB′ shown in FIG. 8B.

FIG. 11A is a cross-sectional view showing a portion of a sensor layer according to an embodiment of the present disclosure in an enlarged manner.

FIG. 11B is a cross-sectional view showing a portion of a sensor layer according to an embodiment of the present disclosure in an enlarged manner.

FIG. 12A is a cross-sectional view showing a portion of a sensor layer according to an embodiment of the present disclosure in an enlarged manner.

FIG. 12B is a cross-sectional view showing a portion of a sensor layer according to an embodiment of the present disclosure in an enlarged manner.

FIG. 13A is a diagram showing an operation of a sensor driver according to an embodiment of the present disclosure.

FIG. 13B is a diagram showing an operation of a sensor driver according to an embodiment of the present disclosure.

FIG. 14 is a diagram illustrating a first mode according to an embodiment of the present disclosure.

FIG. 15 is a diagram illustrating a first mode according to an embodiment of the present disclosure.

FIG. 16 is a diagram illustrating a first mode according to an embodiment of the present disclosure.

FIG. 17 is a diagram illustrating a second mode according to an embodiment of the present disclosure.

FIG. 18 is a diagram illustrating a second mode according to an embodiment of the present disclosure.

FIG. 19 is a diagram illustrating a second mode according to an embodiment of the present disclosure.

FIG. 20 is a plan view of a sensor layer according to an embodiment of the present disclosure.

FIG. 21 is a plan view of a sensor layer according to an embodiment of the present disclosure.

FIG. 22 is a plan view of a sensor layer according to an embodiment of the present disclosure.

FIG. 23 is a plan view of a sensor layer according to an embodiment of the present disclosure.

### DETAILED DESCRIPTION OF THE EMBODIMENTS

Herein, when a component (or a region, a layer, a portion, and the like) is referred to as being “on”, “connected to”, or “coupled to” another component, it means that the component may be directly disposed/connected/coupled on/to another component or a third component may be disposed between the component and another component.

Like reference numerals may refer to like components throughout the specification. In addition, in the drawings, thicknesses, ratios, and dimensions of components may be exaggerated for effective description of technical content. “and/or” includes all of one or more combinations that the associated components may define.

Terms such as first, second, and the like may be used to describe various components, but the components should not be limited by the terms. The above terms are used for the purpose of distinguishing one component from another. For example, a first component may be named as a second component, and similarly, the second component may also be named as the first component. The singular expression includes the plural expression unless the context clearly indicates otherwise.

In addition, terms such as “beneath”, “below”, “on”, “above” are used to describe the relationship of the components shown in the drawings. The above terms are relative concepts, and are described with reference to directions indicated in the drawings.

It should be understood that terms such as “include” or “have” are intended to specify that a feature, a number, a step, an operation, a component, a part, or a combination thereof described herein is present, and do not preclude the possibility of additional or the existence of one or more other features or numbers, steps, operations, components, parts, or combinations thereof.

Here, the terms “part” and “unit” refer to a software component or a hardware component that performs a specific function. The hardware component may include, for example, a field-programmable gate array (FPGA) or an application-specific integrated circuit (ASIC). The software component may refer to executable code and/or data used by the executable code in an addressable storage medium. Thus, the software components may be, for example, object-oriented software components, class components, and task components, and may include processes, functions, properties, procedures, sub-routines, program code segments, drivers, firmware, microcode, circuits, data, databases, data structures, tables, arrays, or variables.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to the drawings.

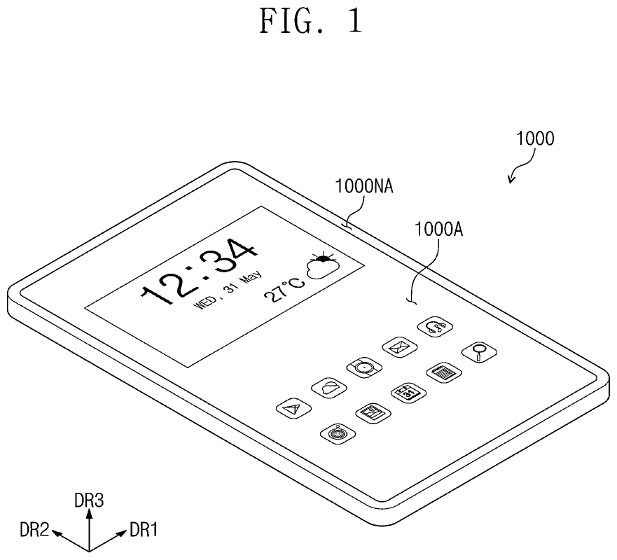

FIG. 1 is a perspective view of an electronic device 1000 according to an embodiment of the present disclosure.

Referring to FIG. 1, the electronic device 1000 may be a device that is activated in response to an electrical signal. For example, the electronic device 1000 may be a mobile phone, a foldable mobile phone, a laptop, a television, a tablet, a vehicle navigation system, a game console, or a wearable device, but may not be limited thereto. FIG. 1 shows that the electronic device 1000 is the mobile phone.

An active area 1000A and a peripheral area 1000NA may be provided in the electronic device 1000. The electronic device 1000 may display an image via the active area 1000A. The active area 1000A may include a surface formed by a first direction DR1 and a second direction DR2. The peripheral area 1000NA may surround the active area 1000A. In one embodiment of the present disclosure, the peripheral area 1000NA may be omitted.

A thickness direction of the electronic device 1000 may be parallel to a third direction DR3 that intersects the first direction DR1 and the second direction DR2. Accordingly, a front surface (or a top surface) and a rear surface (or a bottom surface) of each member constituting the electronic device 1000 may be described based on the third direction DR3.

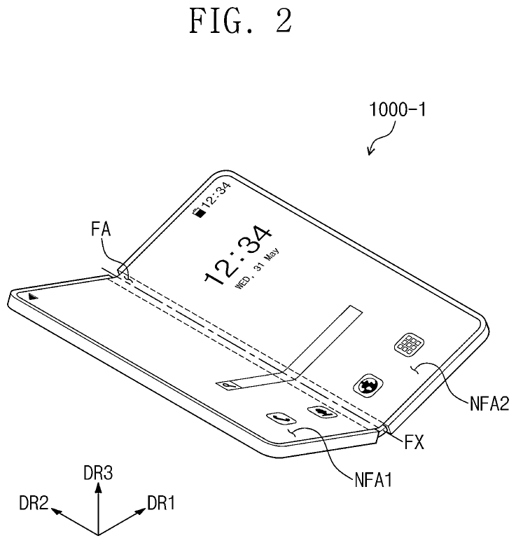

FIG. 2 is a perspective view of an electronic device 1000-1 according to an embodiment of the present disclosure.

Referring to FIG. 2, the electronic device 1000-1 may include a foldable area FA and a plurality of non-foldable areas NFA1 and NFA2. The non-foldable areas NFA1 and NFA2 may include the first non-foldable area NFA1 and the second non-foldable area NFA2. The foldable area FA may be disposed between the first non-foldable area NFA1 and the second non-foldable area NFA2. The foldable area FA may be referred to as a foldable area, and the first and second non-foldable areas NFA1 and NFA2 may be referred to as first and second non-foldable areas.

As shown in FIG. 2, the foldable area FA may be folded with respect to a folding axis FX parallel to the second direction DR2. When the electronic device 1000-1 is folded, the foldable area FA has a predetermined curvature and a radius of curvature. The first non-foldable area NFA1 and the second non-foldable area NFA2 may face each other, and the electronic device 1000-1 may be in-folded such that a display surface is not exposed to the outside.

In one embodiment of the present disclosure, the electronic device 1000-1 may be out-folded such that the display surface is exposed to the outside. In one embodiment of the present disclosure, the electronic device 1000-1 may be in-folded or out-folded from an unfolded state, but the present disclosure may not be limited thereto.

In FIG. 2, an example in which the one folding axis FX is provided in the electronic device 1000-1 is shown, but the present disclosure is not limited thereto. For example, a plurality of folding axes may be provided in the electronic device 1000-1, and the electronic device 1000-1 may be in-folded or out-folded with respect to each of the plurality of folding axes from the unfolded state.

In FIGS. 1 and 2, the bar-type electronic device 1000 and the foldable-type electronic device 1000-1 are respectively described as examples, but the present disclosure is not limited thereto. For example, descriptions to be made below may be applied to various electronic devices, such as a curved electronic device, a rollable electronic device, or a slidable electronic device.

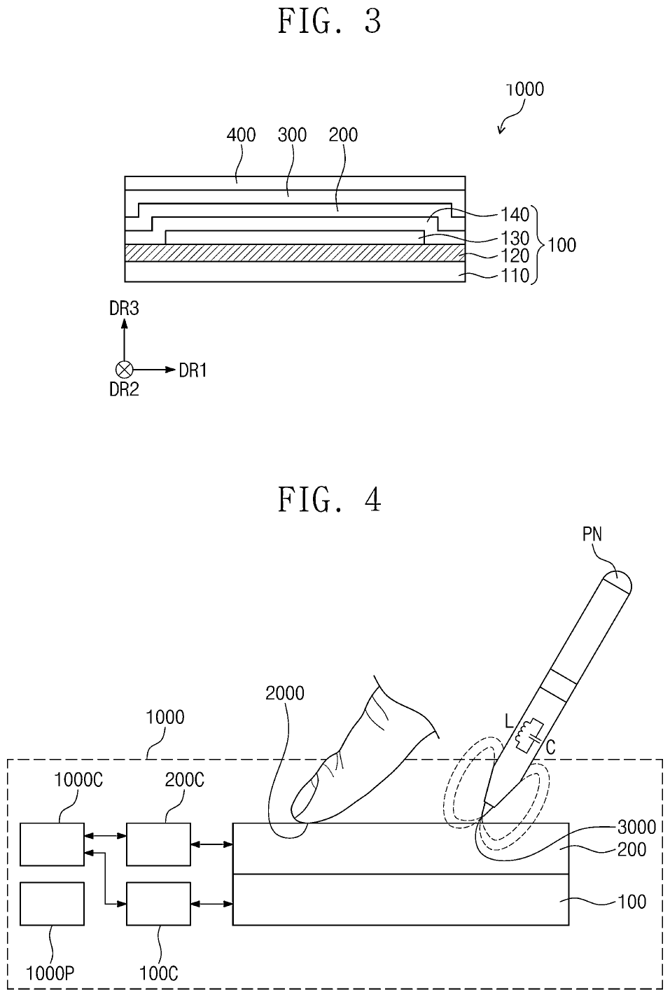

FIG. 3 is a cross-sectional view of the electronic device 1000 according to an embodiment of the present disclosure.

Referring to FIG. 3, the electronic device 1000 may include a display layer 100, a sensor layer 200, an anti-reflection layer 300, and a window 400.

The display layer 100 may include a base layer 110, a circuit layer 120, a light-emitting element layer 130, and an encapsulation layer 140.

The base layer 110 may be a member that provides a base surface on which the circuit layer 120 is disposed. The base layer 110 may be a glass substrate, a metal substrate, a silicon substrate, a polymer substrate, or the like. However, the embodiment may not be limited thereto, and the base layer 110 may be an inorganic layer, an organic layer, or a composite material layer.

The circuit layer 120 may be disposed on the base layer 110. The circuit layer 120 may include an insulating layer, a semiconductor pattern, a conductive pattern, a signal line, and the like. The insulating layer, a semiconductor layer, and a conductive layer may be formed on the base layer 110 using methods such as coating, deposition, and the like, and then, the insulating layer, the semiconductor layer, and the conductive layer may be selectively patterned via a plurality of photolithography processes. Thereafter, the semiconductor pattern, the conductive pattern, and the signal line included in the circuit layer 120 may be formed.

The light-emitting element layer 130 may be disposed on the circuit layer 120. The light-emitting element layer 130 may exposed a portion of the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro light emitting diode (LED), or a nano LED.

The encapsulation layer 140 may be disposed on the light-emitting element layer 130. The encapsulation layer 140 may contact exposed portions of the circuit layer 120. The encapsulation layer 140 may protect the light-emitting element layer 130 from foreign substances such as moisture, oxygen, and dust particles.

The sensor layer 200 may be disposed on the display layer 100. The sensor layer 200 may be formed on the display layer 100 via a continuous process. In this case, the sensor layer 200 may be expressed as being disposed directly on the display layer 100. For example, the sensor layer 200 may be in direct contact with the encapsulation layer 140. The direct disposition may mean that no third component is disposed between the sensor layer 200 and the display layer 100. In other words, a separate adhesive member may not be disposed between the sensor layer 200 and the display layer 100. Alternatively, the sensor layer 200 may be coupled to the display layer 100 via the adhesive member. The adhesive member may include a conventional adhesive or a gluing agent.

The anti-reflection layer 300 may be disposed on the sensor layer 200. The anti-reflection layer 300 may reduce a reflectance of external light incident from the outside of the electronic device 1000. The anti-reflection layer 300 may be disposed directly on top of the sensor layer 200. However, the present disclosure may not be limited thereto, and an adhesive member may be disposed between the anti-reflection layer 300 and the sensor layer 200.

The window 400 may be disposed on the anti-reflection layer 300. An adhesive member may be disposed between the anti-reflection layer 300 and the window 400, but the present disclosure may not be particularly limited thereto. The window 400 may contain an optically transparent insulating material. For example, the window 400 may contain glass or plastic. The window 400 may have a multi-layer structure or a single-layer structure. For example, the window 400 may include a plurality of plastic films bonded together with an adhesive, or may include a glass substrate and a plastic film bonded together with an adhesive.

FIG. 4 is a diagram for illustrating an operation of the electronic device 1000 according to an embodiment of the present disclosure.

Referring to FIG. 4, the electronic device 1000 may include the display layer 100, the sensor layer 200, a display driver 100C, a sensor driver 200C, a main driver 1000C, and a power circuit 1000P.

The display layer 100 may be a component that generates the image. The display layer 100 may be a light-emitting display layer. For example, the display layer 100 may be an organic light-emitting display layer, an inorganic light-emitting display layer, an organic-inorganic light-emitting display layer, a quantum dot display layer, a micro LED display layer, or a nano LED display layer.

The sensor layer 200 may be disposed on the display layer 100. The sensor layer 200 may sense an external input applied from outside. The sensor layer 200 may be an integrated sensor formed continuously during a manufacturing process of the display layer 100, or the sensor layer 200 may be an external sensor attached to the display layer 100. The sensor layer 200 may be referred to as a sensor, an input sensing layer, an input sensing panel, an electronic device for sensing input coordinates, or the like.

The sensor layer 200 may sense a first input 2000 or a second input 3000 applied from the outside. Each of the first input 2000 and the second input 3000 may be an input means that may provide a change in a capacitance of the sensor layer 200, or may be an input means that may cause an induced current in the sensor layer 200. For example, the first input 2000 may be passive-type input means such as a user's body. The second input 3000 may be an input using a pen PN. For example, the pen PN may be a passive-type pen or an active-type pen.

In one embodiment of the present disclosure, the pen PN may be a device that generates a magnetic field of a predetermined resonant frequency. The pen PN may transmit an output signal based on an electromagnetic resonance scheme. The pen PN may be referred to as an input device, an input pen, a magnetic pen, a stylus pen, or an electromagnetic resonance pen.

The pen PN may include an LC resonance circuit, and the LC resonance circuit may include an inductor L and a capacitor C. In one embodiment of the present disclosure, the LC resonant circuit may be a variable resonant circuit that varies the resonant frequency. In this case, the inductor L may be a variable inductor and/or the capacitor C may be a variable capacitor, but the present disclosure may not be particularly limited thereto.

The inductor L generates a current by a magnetic field formed in the sensor layer 200. The generated current is transferred to the capacitor C. The capacitor C stores a charge from the current input from the inductor L and discharges the stored charge to the inductor L. Thereafter, the inductor L may emit a magnetic field at the resonant frequency. An induced current may flow in the sensor layer 200 by the magnetic field emitted by the pen PN, and the induced current may be transmitted to the sensor driver 200C as a reception signal or a sensing signal.

The main driver 1000C may control overall operations of the electronic device 1000. For example, the main driver 1000C may control operations of the display driver 100C and the sensor driver 200C. The main driver 1000C may include at least one microprocessor and may further include a graphics controller. The main driver 1000C may be an application processor, a central processing unit, or a main processor.

The display driver 100C may drive the display layer 100. The display driver 100C may receive image data and a control signal from the main driver 1000C. The control signal may include various signals. For example, the control signal may include an input vertical sync signal, an input horizontal sync signal, a main clock, a data enable signal, and the like.

The sensor driver 200C may drive the sensor layer 200. The sensor driver 200C may receive the control signal from the main driver 1000C. The control signal may include a clock signal of the sensor driver 200C. Additionally, the control signal may further include a mode determining signal that determines a driving mode of the sensor driver 200C and the sensor layer 200.

The sensor driver 200C and the sensor layer 200 may operate in a first mode or a second mode. For example, the first mode may be a mode that senses the touch input, for example, the first input 2000. The second mode may be a mode that senses the pen PN input, for example, the second input 3000. The second mode may include a charging section and a pen sensing section. The first mode may be referred to as a touch sensing mode, and the second mode may be referred to as a pen sensing mode. The charging section may be referred to as a charging time period, and the pen sensing section may be referred to as a pen sensing time period.

Switching between the touch sensing mode and the pen sensing mode may be performed in various ways. For example, the sensor driver 200C and the sensor layer 200 may sense the first input 2000 and the second input 3000 via a time-sharing operation. Alternatively, the switching between the touch sensing mode and the pen sensing mode may be made by user selection, or one of the touch sensing mode and the pen sensing mode may be activated or switched by activation of a specific application. Alternatively, while the sensor driver 200C and the sensor layer 200 are alternately operating in the touch sensing mode and the pen sensing mode, the touch sensing mode may be maintained when the first input 2000 is sensed, or the pen sensing mode may be maintained when the second input 3000 is sensed.

The sensor driver 200C may calculate coordinate information of the input based on a signal received from the sensor layer 200 and provide a coordinate signal with the coordinate information to the main driver 1000C. The main driver 1000C executes an operation corresponding to the user input based on the coordinate signal. For example, the main driver 1000C may operate the display driver 100C such that a new application image is displayed on the display layer 100.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include a gate high voltage, a gate low voltage, an ELVSS voltage, an ELVDD voltage, an initialization voltage, and the like, but may not be particularly limited to the above examples.

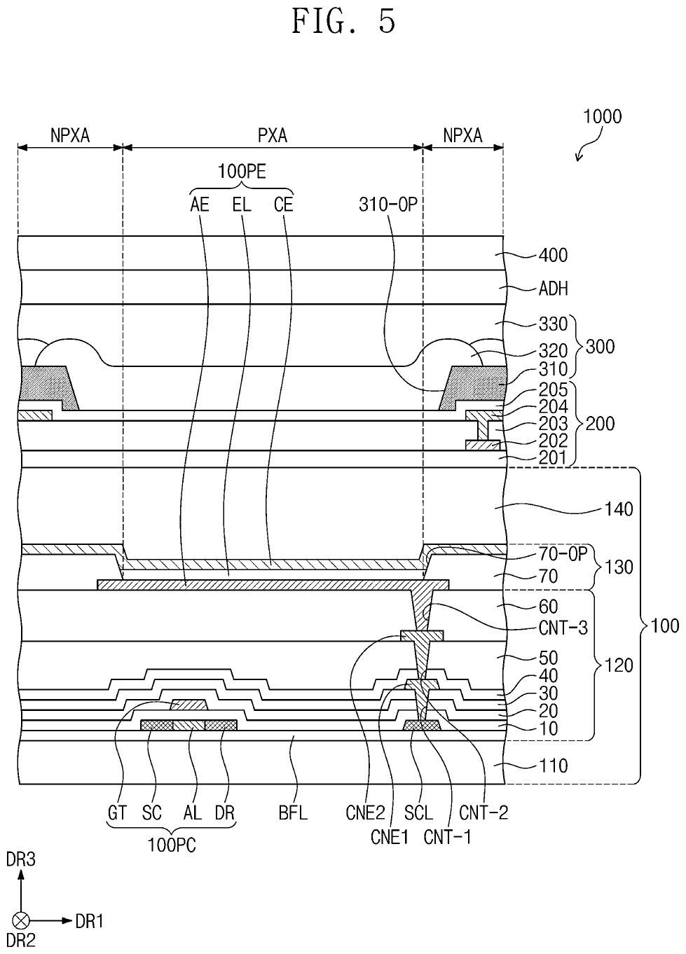

FIG. 5 is a cross-sectional view of the electronic device 1000 according to an embodiment of the present disclosure.

Referring to FIG. 5, the electronic device 1000 may include the display layer 100, the sensor layer 200, the anti-reflection layer 300, an adhesive layer ADH, and the window 400. The adhesive layer ADH may be disposed between the anti-reflection layer 300 and the window 400. The adhesive layer ADH may include a conventional adhesive or a gluing agent that has light transparency.

At least one inorganic layer is formed on a top surface of the base layer 110. The inorganic layer may contain at least one of aluminum oxide, titanium oxide, silicon oxide, silicon nitride, silicon oxy nitride, zirconium oxide, and hafnium oxide. The inorganic layer may be formed in multiple layers. The multiple inorganic layers may constitute a barrier layer and/or a buffer layer. In the present embodiment, the display layer 100 is shown as including a buffer layer BFL.

The buffer layer BFL may improve a bonding strength between the base layer 110 and the semiconductor pattern. The buffer layer BFL may contain at least one of silicon oxide, silicon nitride, or silicon oxynitride. For example, the buffer layer BFL may include a structure in which a silicon oxide layer and a silicon nitride layer are alternately stacked.

The semiconductor pattern may be disposed on the buffer layer BFL. The semiconductor pattern may contain polysilicon. However, without being limited thereto, the semiconductor pattern may include amorphous silicon, low-temperature polycrystalline silicon, or an oxide semiconductor.

FIG. 5 only shows a partial semiconductor pattern, and the semiconductor pattern may further be arranged in another area. The semiconductor pattern may be arranged in a specific rule across pixels. The semiconductor pattern may have different electrical properties depending on whether or not it is doped. The semiconductor pattern may include a first area with high conductivity and a second area with low conductivity. The first area may be doped with an N-type dopant or a P-type dopant. A P-type transistor may include a doped area doped with the P-type dopant, and an N-type transistor may include a doped area doped with the N-type dopant. The second area may be a non-doped area or an area doped at a lower concentration than the first area.

The first area may have the conductivity greater than that of the second area, and may serve as an electrode or a signal line. The second area may correspond to an active area or a channel of the transistor. In other words, a portion of the semiconductor pattern may be the active area of the transistor, another portion of the semiconductor pattern may be a source or a drain of the transistor, and still another portion of the semiconductor pattern may be a connection electrode or a connection signal line.

Each of the pixels may have an equivalent circuit including seven transistors, one capacitor, and the light-emitting element, and an equivalent circuit diagram of the pixel may be modified into various forms. FIG. 5 shows one transistor 100PC and a light-emitting element 100PE included in the pixel as an example.

A source area SC, an active area AL, and a drain area DR of the transistor 100PC may be formed from the semiconductor pattern. The source area SC and the drain area DR may extend in opposite directions from the active area AL on a cross-section. FIG. 5 shows a portion of a connection signal line SCL formed from the semiconductor pattern. The connection signal line SCL may be connected to the drain area DR of the transistor 100PC on a plane.

A first insulating layer 10 may be disposed on the buffer layer BFL. The first insulating layer 10 may commonly overlap the plurality of pixels and may cover the semiconductor pattern. The first insulating layer 10 may be an inorganic layer and/or an organic layer, and may have a single-layer or multi-layer structure. The first insulating layer 10 may contain at least one of aluminum oxide, titanium oxide, silicon oxide, silicon nitride, silicon oxynitride, zirconium oxide, or hafnium oxide. In the present embodiment, the first insulating layer 10 may be a silicon oxide layer of a single layer. The first insulating layer 10 as well as an insulating layer of the circuit layer 120 to be described later may be an inorganic layer and/or an organic layer and may have a single-layer or multi-layer structure. The inorganic layer may contain at least one of the above-mentioned materials, but may not be limited thereto.

A gate GT of the transistor 100PC is disposed on the first insulating layer 10. The gate GT may be a portion of a metal pattern. The gate GT overlaps the active area AL with the first insulating layer 10 therebetween. In the process of doping the semiconductor pattern, the gate GT may function as a mask.

A second insulating layer 20 may be disposed on the first insulating layer 10 and may cover the gate GT. The second insulating layer 20 may overlap the pixels in common. The second insulating layer 20 may be an inorganic layer and/or an organic layer, and may have a single-layer or a multi-layer structure. The second insulating layer 20 may contain at least one of silicon oxide, silicon nitride, or silicon oxy nitride. In the present embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer or a multi-layer structure. For example, the third insulating layer 30 may have the multi-layer structure including a silicon oxide layer and a silicon nitride layer.

A first connection electrode CNE1 may be disposed on the third insulating layer 30. The first connection electrode CNE1 may be connected to the connection signal line SCL via a contact hole CNT-1 extending through the first, second, and third insulating layers 10, 20, and 30. For example, the first connection electrode CNE1 may make direct contact with the connection signal line SCL in the contact hole CNT-1.

A fourth insulating layer 40 may be disposed on the third insulating layer 30. The fourth insulating layer 40 may be a silicon oxide layer of a single layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 via a contact hole CNT-2 extending through the fourth insulating layer 40 and the fifth insulating layer 50. For example, the second connection electrode CNE2 may make direct contact with the first connection electrode CNE1 in the contact hole CNT-2.

A sixth insulating layer 60 may be disposed on the fifth insulating layer 50 and may cover the second connection electrode CNE2. The sixth insulating layer 60 may be an organic layer.

The light-emitting element layer 130 may be disposed on the circuit layer 120. The light-emitting element layer 130 may include the light-emitting element 100PE. For example, the light-emitting element layer 130 may include the organic light-emitting material, the inorganic light-emitting material, the organic-inorganic light-emitting material, the quantum dot, the quantum rod, the micro LED, or the nano LED. Hereinafter, a description will be made with an example in which the light-emitting element 100PE is the organic light-emitting element, but the present disclosure is not particularly limited thereto.

The light-emitting element 100PE may include a first electrode AE, a light-emitting layer EL, and a second electrode CE.

The first electrode AE may be disposed on the sixth insulating layer 60. The first electrode AE may be connected to the second connection electrode CNE2 via a contact hole CNT-3 extending through the sixth insulating layer 60. For example, the first electrode AE may make direct contact with the second connection electrode CNE2 in the contact hole CNT-3.

A pixel defining layer 70 may be disposed on the sixth insulating layer 60 and may cover a portion of the first electrode AE. An opening 70-OP is formed in the pixel defining layer 70. The opening 70-OP of the pixel defining layer 70 exposes at least a portion of the first electrode AE.

The active area 1000A (see FIG. 1) may include a light-emitting area PXA and a non-light-emitting area NPXA adjacent to the light-emitting area PXA. The non-light-emitting area NPXA may surround the light-emitting area PXA. In the present embodiment, the light-emitting area PXA corresponds to a portion of the first electrode AE exposed by the opening 70-OP.

The light-emitting layer EL may be disposed on the first electrode AE. The light-emitting layer EL may be disposed in an area corresponding to the opening 70-OP. For example, the light-emitting layer EL may be formed separately in each pixel. When the light-emitting layer EL is formed separately in each pixel, each light-emitting layer EL may emit light of at least one color among blue, red, and green. However, the present disclosure may not be limited thereto, and the light-emitting layer EL may be connected to and commonly included in the pixels. In this case, the light-emitting layer EL may provide blue light or white light.

The second electrode CE may be disposed on the light-emitting layer EL. The second electrode CE may have an integral shape and may be commonly included for the plurality of pixels.

A hole control layer may be disposed between the first electrode AE and the light-emitting layer EL. The hole control layer may be commonly disposed in the light-emitting area PXA and the non-light-emitting area NPXA. The hole control layer may include a hole transport layer and may further include a hole injection layer. An electronic control layer may be disposed between the light-emitting layer EL and the second electrode CE. The electronic control layer may include an electron transport layer and may further include an electron injection layer. The hole control layer and the electronic control layer may be commonly formed in the plurality of pixels using an open mask or an inkjet process.

The encapsulation layer 140 may be disposed on the light-emitting element layer 130. The encapsulation layer 140 may include an inorganic layer, an organic layer, and an inorganic layer sequentially stacked, but layers constituting the encapsulation layer 140 may not be limited thereto. The inorganic layers may protect the light-emitting element layer 130 from moisture and oxygen, and the organic layer may protect the light-emitting element layer 130 from foreign substances such as dust particles. The inorganic layers may include a silicon nitride layer, a silicon oxy nitride layer, a silicon oxide layer, a titanium oxide layer, an aluminum oxide layer, or the like. The organic layer may include an acrylic-based organic layer, but may not be limited thereto.

The sensor layer 200 may include a base layer 201, a first conductive layer 202, a sensing insulating layer 203, a second conductive layer 204, and a cover insulating layer 205.

The base layer 201 may be an inorganic layer containing at least one of silicon nitride, silicon oxy nitride, and silicon oxide. Alternatively, the base layer 201 may be an organic layer containing epoxy resin, acrylic resin, or imide-based resin. The base layer 201 may have a single-layer structure or a structure of multiple layers stacked along the third direction DR3.

Each of the first conductive layer 202 and the second conductive layer 204 may have a single-layer structure or a structure of multiple layers stacked along the third direction DR3.

The single-layer conductive layer may include a metal layer or a transparent conductive layer. The metal layer may contain molybdenum, silver, titanium, copper, aluminum, or alloys thereof. The transparent conductive layer may contain a transparent conductive oxide such as indium tin oxide (ITO), indium zinc oxide (IZO), zinc oxide (ZnO), or indium zinc tin oxide (IZTO). In addition, the transparent conductive layer may contain a conductive polymer such as poly(3,4-ethylenedioxythiophene) (PEDOT), metal nanowire, graphene, and the like.

The conductive layer of the multi-layer structure may include metal layers. The metal layers may have, for example, a three-layer structure of titanium/aluminum/titanium. The conductive layer of the multi-layer structure may include at least one metal layer and at least one transparent conductive layer.

At least one of the sensing insulating layer 203 and the cover insulating layer 205 may include an inorganic film. The inorganic film may contain at least one of aluminum oxide, titanium oxide, silicon oxide, silicon nitride, silicon oxy nitride, zirconium oxide, and hafnium oxide.

At least one of the sensing insulating layer 203 and the cover insulating layer 205 may include an organic film. The organic film may contain at least one of acrylic resin, methacrylic resin, polyisoprene, vinyl-based resin, epoxy-based resin, urethane-based resin, cellulose-based resin, siloxane-based resin, polyimide-based resin, polyamide-based resin, or perylene-based resin.

The anti-reflection layer 300 may be disposed on the sensor layer 200. The anti-reflection layer 300 may include a dividing layer 310, a plurality of color filters 320, and a planarization layer 330.

The dividing layer 310 may overlap a conductive pattern of the second conductive layer 204. The dividing layer 310 may also overlap the pixel defining layer 70. The cover insulating layer 205 may be disposed between the dividing layer 310 and the second conductive layer 204. In another embodiment of the present disclosure, the cover insulating layer 205 may be omitted.

The dividing layer 310 may prevent external light reflection by the second conductive layer 204. A material constituting the dividing layer 310 is not particularly limited as long as it is a material that absorbs light. The dividing layer 310 is a layer with a black color. In one embodiment, the dividing layer 310 may contain a black coloring agent. The black coloring agent may contain a black dye and a black pigment. The black coloring agent may include metals such as carbon black and chromium, or oxides thereof.

A split opening 310-OP may be provided in the dividing layer 310. The split opening 310-OP may overlap the light-emitting layer EL. The color filter 320 may be disposed to correspond to the split opening 310-OP. The color filter 320 may transmit light provided from the light-emitting layer EL that overlaps the color filter 320.

The planarization layer 330 may cover the dividing layer 310 and the color filter 320. The planarization layer 330 may contain an organic material and provide a flat surface at a top surface thereof. In one embodiment, the planarization layer 330 may be omitted.

In one embodiment of the present disclosure, the anti-reflection layer 300 may include a reflection adjustment layer instead of the color filters 320. For example, in the illustration of FIG. 5, the color filters 320 may be omitted, and the reflection adjustment layer may be added in a place of the color filters 320. The reflection adjustment layer may selectively absorb light of some bands of light reflected from the inside of a display panel and/or the electronic device or light incident from the outside of the display panel and/or the electronic device.

As an example, the reflection adjustment layer may absorb light of a first wavelength area in a range from 490 nm to 505 nm and a second wavelength area in a range from 585 nm to 600 nm, so that a light transmittance in the first wavelength area and the second wavelength area may be equal to or lower than 40%. The reflection adjustment layer may absorb light of a wavelength out of wavelength ranges of red, green, and blue light emitted from the light-emitting layer EL. As such, the reflection adjustment layer absorbs light of the wavelength that does not fall within the wavelength range of red, green, or blue light emitted from the light-emitting layer EL, thereby preventing or minimizing a decrease in luminance of the display panel and/or the electronic device. Additionally, by employing the reflection adjustment layer, a decrease in light emitting efficiency of the display panel and/or the electronic device may be prevented or minimized, and visibility may be improved.

The reflection adjustment layer may be formed as an organic material layer containing a dye, a pigment, or a combination thereof. The reflection adjustment layer may contain a tetraazaporphyrin (TAP)-based compound, a porphyrin-based compound, a metal porphyrin-based compound, an oxazine-based compound, a squarylium-based compound, a triarylmethane-based compound, a polymethine-based compound, an anthraquinone-based compound, a phthalocyanine-based compound, an azo-based compound, a perylene-based compound, a xanthene-based compound, a diimmonium-based compound, a dipyrromethene-based compound, a cyanine-based compound, and a combination thereof.

In one embodiment, the reflection adjustment layer may have the transmittance in a range from about 64% to 72%. The transmittance of the reflection adjustment layer may be adjusted depending on a content of the pigment and/or the dye contained in the reflection adjustment layer.

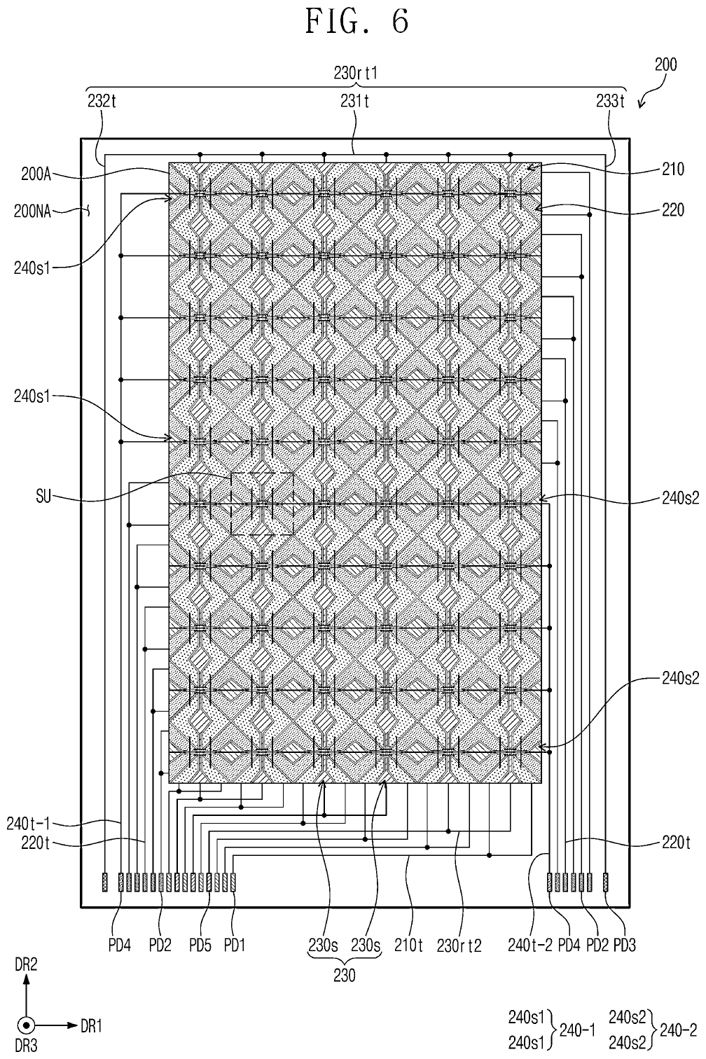

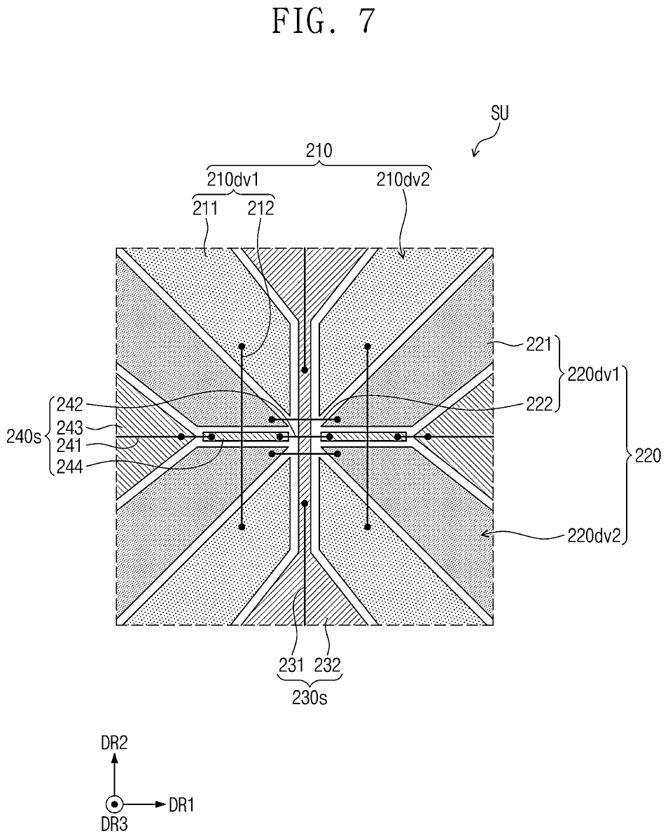

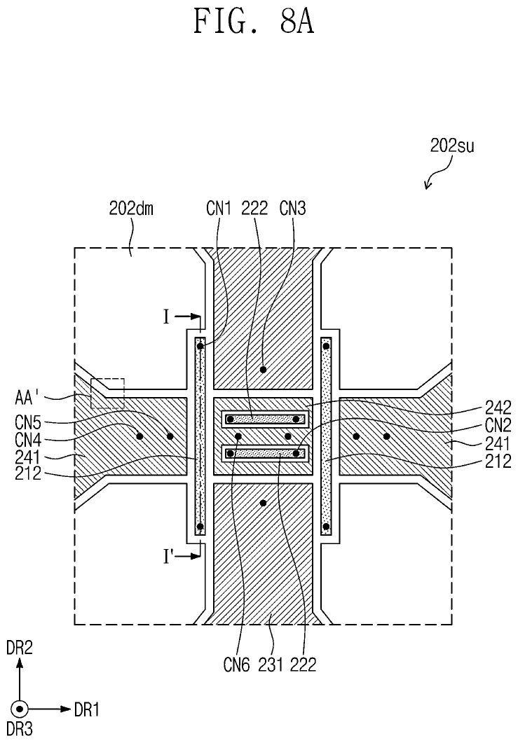

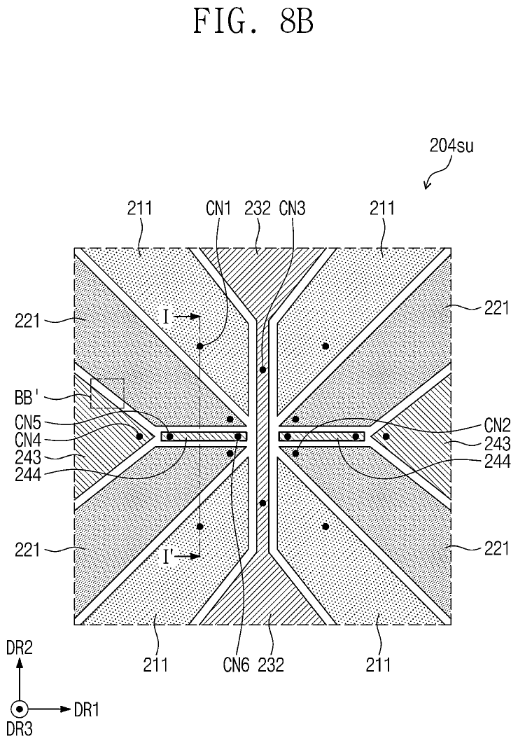

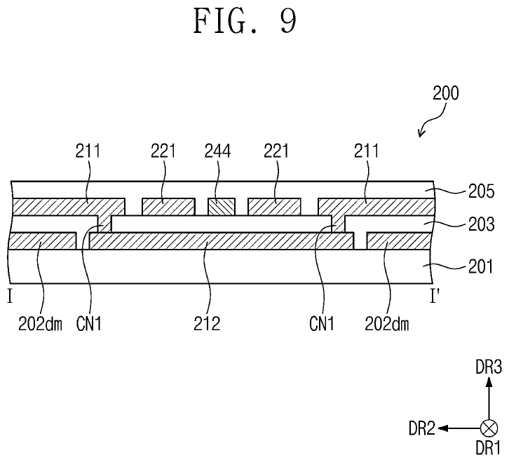

FIG. 6 is a plan view of the sensor layer 200 according to an embodiment of the present disclosure. FIG. 7 is an enlarged plan view of a sensing unit SU according to an embodiment of the present disclosure. FIG. 8A is a plan view showing a first conductive layer 202su of the sensing unit SU according to an embodiment of the present disclosure. FIG. 8B is a plan view showing a second conductive layer 204su of the sensing unit SU according to an embodiment of the present disclosure. FIG. 9 is a cross-sectional view of the sensor layer 200 according to an embodiment of the present disclosure taken along line I-I′ shown in each of FIGS. 8A and 8B.

Referring to FIG. 6, a sensing area 200A and a peripheral area 200NA adjacent to the sensing area 200A may be provided in the sensor layer 200.

The sensor layer 200 may include a plurality of first electrodes 210, a plurality of second electrodes 220, a plurality of third electrodes 230, and a plurality of fourth electrodes 240-1 and 240-2 disposed in the sensing area 200A. The first electrodes 210 may be referred to as first touch electrodes, the second electrodes 220 may be referred to as second touch electrodes, the third electrodes 230 may be referred to as first pen electrodes, and the fourth electrodes 240-1 and 240-2 may be referred to as second pen electrodes.

Each of the first electrodes 210 may intersect with the second electrodes 220. Each of the first electrodes 210 may extend along the second direction DR2, and the first electrodes 210 may be spaced apart from each other in the first direction DR1. For example, columns of the first electrodes 210 may be spaced apart from each other in the first direction DR1. Each of the second electrodes 220 may extend along the first direction DR1, and the second electrodes 220 may be spaced apart from each other in the second direction DR2. For example, rows of the second electrodes 220 may be spaced apart from each other in the second direction DR2. The sensing unit SU may be an area where the one first electrode 210 and the one second electrode 220 intersect with each other.

In FIG. 6, the six first electrodes 210 and the ten second electrodes 220 are shown as an example, and the sixty sensing units SU are shown as an example, but the number of first electrodes 210, the number of second electrodes 220 and the number of the sensing units SU are not limited thereto.

Referring to FIGS. 6 and 7, each of the first electrodes 210 may include first split electrodes 210dv1 and 210dv2. The first split electrodes 210dv1 and 210dv2 may extend along the second direction DR2 and may be spaced apart from each other in the first direction DR1. The first split electrodes 210dv1 and 210dv2 may have a shape symmetrical around a line extending in the second direction DR2.

Each of the second electrodes 220 may include second split electrodes 220dv1 and 220dv2. The second electrodes 220 may extend along the first direction DR1 and may be spaced apart from each other in the second direction DR2. The second split electrodes 220dv1 and 220dv2 may have a shape symmetrical around a line extending in the first direction DR1.

Referring to FIGS. 7, 8A, 8B, and 9, each of the first split electrodes 210dv1 and 210dv2 may include a first pattern 211 and a first bridge pattern 212, and each of the second split electrodes 220dv1 and 220dv2 may include a second pattern 221 and a second bridge pattern 222.

The first pattern 211 and the first bridge pattern 212 may be disposed on different layers, and the first pattern 211 and the first bridge pattern 212 may be electrically connected to each other via a first contact CN1. The second pattern 221 and the second bridge pattern 222 may be disposed on different layers, and the second pattern 221 and the second bridge pattern 222 may be electrically connected to each other via a second contact CN2. For example, the first bridge pattern 212 and the second bridge pattern 222 may be included in the first conductive layer 202su, and the first pattern 211 and the second pattern 221 may be included in the second conductive layer 204su. The first conductive layer 202su may be included in the first conductive layer 202 in FIG. 5, and the second conductive layer 204su may be included in the second conductive layer 204 in FIG. 5.

Each of the third electrodes 230 may extend along the second direction DR2, and the third electrodes 230 may be spaced apart from each other in the first direction DR1. For example, columns of the third electrodes 230 may be spaced apart from each other in the first direction DR1.

In one embodiment of the present disclosure, each of the third electrodes 230 may include a plurality of first sub-electrodes 230s electrically connected each other. The plurality of first sub-electrodes 230s may be connected in parallel with each other. The number of first sub-electrodes 230s included in each of the third electrodes 230 may be varied. For example, as the number of first sub-electrodes 230s included in each of the third electrodes 230 increases, a resistance of each of the third electrodes 230 decreases. In addition, an effect can be observed from increasing the size of each of the third electrodes 230. For example, a coupling capacitance between the first electrodes 210 and the third electrodes 230 may be increased, thereby improving a sensing sensitivity for the second input 3000 (see FIG. 4). Conversely, as the number of first sub-electrodes 230s included in each of the third electrodes 230 decreases, a loop coil pattern formed using the third electrodes 230 may become more dense, and thus, the sensing sensitivity may be improved. In addition, the number of fourth pads PD4 connected in one-to-one correspondence with the third electrodes 230 may decrease, and thus, a dead space may be reduced.

Although FIG. 6 shows, as an example, that the one third electrode 230 includes the two first sub-electrodes 230s, the present disclosure is not particularly limited thereto. The first sub-electrodes 230s may be arranged in one-to-one correspondence with the first electrodes 210. Accordingly, the one sensing unit SU may include a portion of the one first sub-electrode 230s.

In one embodiment of the present disclosure, the one third electrode 230 includes the two first sub-electrodes 230s, so that the one third electrode 230 may correspond to two of the first electrodes 210. Accordingly, the number of first electrodes 210 included in the sensor layer 200 may be greater than the number of third electrodes 230. For example, the number of first electrodes 210 may be equal to the product of the number of third electrodes 230 included in the sensor layer 200 and the number of first sub-electrodes 230s included in each of the third electrodes 230. In FIG. 6, the number of first electrodes 210 may be six, the number of third electrodes 230 may be three, and the number of first sub-electrodes 230s included in each of the third electrodes 230 may be two.

The plurality of fourth electrodes 240-1 and 240-2 may be spaced apart from each other in the second direction DR2. The fourth electrode 240-1 may include a plurality of sub-electrodes 240s1 (hereinafter, referred to as second sub-electrodes) connected in parallel with each other, and the fourth electrode 240-2 may include a plurality of sub-electrodes 240s2 (hereinafter, referred to as second sub-electrodes) connected in parallel with each other. It is shown as an example in FIG. 6 that each of the plurality of fourth electrodes 240-1 and 240-2 includes the five sub-electrodes 240s1 or 240s2, but the present disclosure is not particularly limited thereto.

The second sub-electrodes 240s1 and 240s2 may be arranged along the second direction DR2, and each of the second sub-electrodes 240s1 and 240s2 may extend along the first direction DR1. The number of second sub-electrodes 240s1 and 240s2 included in the plurality of fourth electrodes 240-1 and 240-2 may be equal to or smaller than the number of second electrodes 220.

When the plurality of fourth electrodes 240-1 and 240-2 include the second sub-electrodes 240s1 and 240s2, the size of each of the plurality of fourth electrodes 240-1 and 240-2 may increase. In this case, a coupling capacitance between each of the plurality of fourth electrodes 240-1 and 240-2 and the second electrodes 220 may increase. The greater the coupling capacitance, the better the sensing sensitivity for the second input 3000 (see FIG. 4). Accordingly, a sensing sensitivity of the sensor layer 200 may be improved.

In one embodiment of the present disclosure, the sensor layer 200 may include the one fourth electrode, e.g., 240-1, and accordingly, the number of second sub-electrodes, e.g., 240s1, included in the one fourth electrode, e.g., 240-1, may be the same as the number of second electrodes 220. However, the present disclosure is not limited thereto. For example, the sensor layer 200 may include the plurality of fourth electrodes 240-1 and 240-2 spaced apart from each other in the second direction DR2. In this case, each of the plurality of fourth electrodes 240-1 and 240-2 may include the plurality of second sub-electrodes 240s1 and 240s2.

Referring to FIGS. 6, 8A, and 8B, each of the first sub-electrodes 230s may include a third-first pattern 231 and a third-second pattern 232. The third-first pattern 231 and the third-second pattern 232 may be disposed on different layers, and the third-first pattern 231 and the third-second pattern 232 may be electrically connected to each other via a third contact CN3.

Each of the second sub-electrodes 240s1 and 240s2 may include a fourth-first pattern 241, a fourth-second pattern 242, a fourth-third pattern 243, and a fourth-fourth pattern 244. The fourth-first pattern 241 and the fourth-second pattern 242 may be disposed on the same layer, and the fourth-third pattern 243 and the fourth-fourth pattern 244 may be disposed on the same layer, but may be disposed on a different layer from the fourth-first pattern 241 and the fourth-second pattern 242. For example, the fourth-first pattern 241 and the fourth-third pattern 243 may be electrically connected to each other via a fourth contact CN4, and the fourth-fourth pattern 244 may be electrically connected to the fourth-first pattern 241 via a fifth contact CN5 and electrically connected to the fourth-second pattern 242 via a sixth contact CN6.

The third-first pattern 231, the fourth-first pattern 241, and the fourth-second pattern 242 may be included in the first conductive layer 202su, and the third-second pattern 232, the fourth-third pattern 243, and the fourth-fourth pattern 244 may be included in the second conductive layer 204su.

In one embodiment of the present disclosure, the first conductive layer 202su may further include dummy patterns 202dm. Each of the dummy patterns 202dm may be electrically floating or electrically grounded. Each of the dummy patterns 202dm may be electrically insulated from the first bridge pattern 212, the second bridge pattern 222, the third-first pattern 231, the fourth-first pattern 241, and the fourth-second pattern 242. In one embodiment of the present disclosure, the dummy patterns 202dm may be omitted.

The sensor layer 200 may further include a plurality of first trace lines 210t disposed in the peripheral area 200NA, a plurality of first pads PD1 connected in one-to-one correspondence to the first trace lines 210t, a plurality of second trace lines 220t, and a plurality of second pads PD2 connected in one-to-one correspondence to the second trace lines 220t.

The first trace lines 210t may be in the one-to-one correspondence and electrically connected to the first electrodes 210, respectively, and the second trace lines 220t may be in the one-to-one correspondence and electrically connected to the second electrodes 220, respectively. Accordingly, the two first split electrodes 210dv1 and 210dv2 included in the one first electrode 210 may be connected to one of the first trace lines 210t. Two second split electrodes 220dv1 and 220dv2 included in the one second electrode 220 may be connected to one of the second trace lines 220t. Each of the second trace lines 220t may include a plurality of branches to be connected to the two second split electrodes 220dv1 and 220dv2.

The sensor layer 200 may further include a third trace line 230rt1 disposed in the peripheral area 200NA, a plurality of third pads PD3 connected to a first end and a second end of the third trace line 230rt1, fourth trace lines 240t-1 and 240t-2, fourth pads PD4 connected in one-to-one correspondence to the fourth trace lines 240t-1 and 240t-2, fifth trace lines 230rt2, and a fifth pad PD5 connected in one-to-one correspondence to the fifth trace lines 230rt2.

The third trace line 230rt1 may be electrically connected to all of the third electrodes 230. The third trace line 230rt1 may include a first line portion 231t extending along the first direction DR1 and electrically connected to the third electrodes 230, a second line portion 232t extending along the second direction DR2 from a first end of the first line portion 231t, and a third line portion 233t extending along the second direction DR2 from a second end of the first line portion 231t. The first line portion 231t may be referred to as a first portion, the second line portion 232t may be referred to as a second portion, and the third line portion 233t may be referred to as a third portion. The second line portion 232t may extend to the leftmost third pad PD3 and the third line portion 233t may extend to the rightmost third pad PD3.

In one embodiment of the present disclosure, each of a resistance of the second line portion 232t and a resistance of the third line portion 233t may be substantially equal to a resistance of one of the third electrodes 230. Accordingly, the second line portion 232t and the third line portion 233t may function as the third electrodes 230, and the same effect obtained when the third electrodes 230 are also disposed in the peripheral area 200NA may be obtained. For example, one of the second line portion 232t and the third line portion 233t and one of the third electrodes 230 may form a coil. Accordingly, the pen PN disposed in an area adjacent to the peripheral area 200NA may also be sufficiently charged by the loop or coil including the second line portion 232t or the third line portion 233t.

In one embodiment of the present disclosure, to adjust the resistance of the second line portion 232t and the resistance of the third line portion 233t, a width of each of the second line portion 232t and the third line portion 233t in the first direction DR1 may be adjusted. However, this is only an example, and the first to third line portions 231t, 232t, and 233t may have substantially the same width.

The fifth trace lines 230rt2 may be connected in one-to-one correspondence to the third electrodes 230. In other words, the number of fifth trace lines 230rt2 may correspond to the number of third electrodes 230. In FIG. 6, the three fifth trace lines 230rt2 are shown as an example.

At least one of the fifth trace lines 230rt2 may overlap at least one of the first trace lines 210t. Therefore, an area size of the peripheral area 200NA may be reduced.

The fourth trace lines 240t-1 and 240t-2 may be spaced apart from each other with the sensing area 200A interposed therebetween. One end of each of the second sub-electrodes 240s1 may be connected to the fourth trace line 240t-1. One end of each of the second sub-electrodes 240s2 may be connected to the fourth trace line 240t-2. Since all of the second sub-electrodes 240s1 are connected to the fourth trace line 240t-1, the second sub-electrodes 240s1 may function as one electrode. Additionally, because all of the second sub-electrodes 240s2 are connected to the fourth trace line 240t-2, the second sub-electrodes 240s2 may function as one electrode. Therefore, an effect similar to expanding a size of each of the plurality of fourth electrodes 240-1 and 240-2 can be achieved. As a result, the coupling capacitance between each of the plurality of fourth electrodes 240-1 and 240-2 and the second electrodes 220 may be increased. The greater the coupling capacitance, the better the sensing sensitivity for the second input 3000 (see FIG. 4). Accordingly, the sensing sensitivity of the sensor layer 200 may be improved.

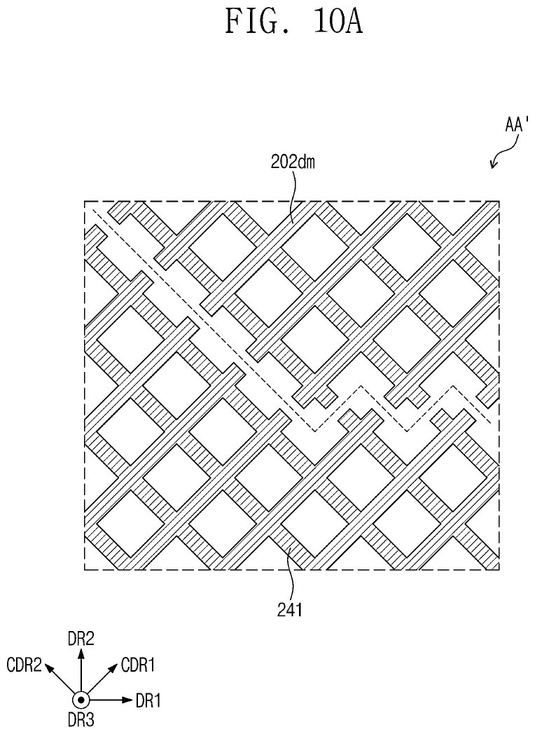

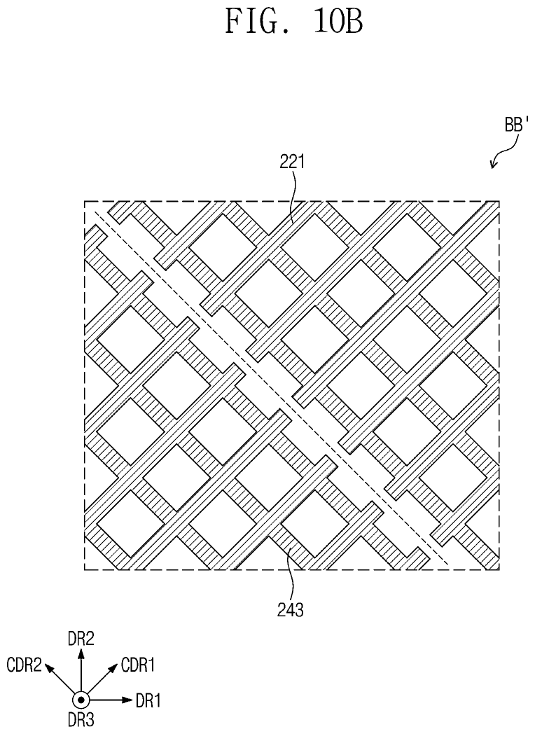

FIG. 10A is an enlarged plan view of area AA′ shown in FIG. 8A. FIG. 10B is an enlarged plan view of area BB′ shown in FIG. 8B.

Referring to FIGS. 8A, 8B, 10A, and 10B, each of the first electrodes 210, the second electrodes 220, the third electrodes 230, the plurality of fourth electrodes 240-1 and 240-2, and the dummy patterns 202dm may have a mesh structure. Each of the mesh structures may include a plurality of mesh lines. The plurality of mesh lines may have a shape extending in a predetermined direction and may be connected to each other. The shape may have various shapes such as a straight line, a line with protrusions, or an uneven line. An opening in which the mesh structure is not disposed may be formed in each of the first electrodes 210, the second electrodes 220, the third electrodes 230, the plurality of fourth electrodes 240-1 and 240-2, and the dummy patterns 202dm.

It is shown as an example in FIGS. 10A and 10B that the mesh structure includes mesh lines extending along a first intersection direction CDR1 that intersects with the first direction DR1 and the second direction DR2, and mesh lines extending along a second intersection direction CDR2 that intersects with the first intersection direction CDR1. However, an extension direction of the mesh lines constituting the mesh structure is not particularly limited to that shown in FIGS. 10A and 10B. For example, the mesh structure may include only mesh lines extending in the first direction DR1 and the second direction DR2, or include mesh lines extending in the first direction DR1, the second direction DR2, and the first intersection direction CDR1 and the second intersection direction CDR2. In other words, the mesh structure may be changed into various forms.

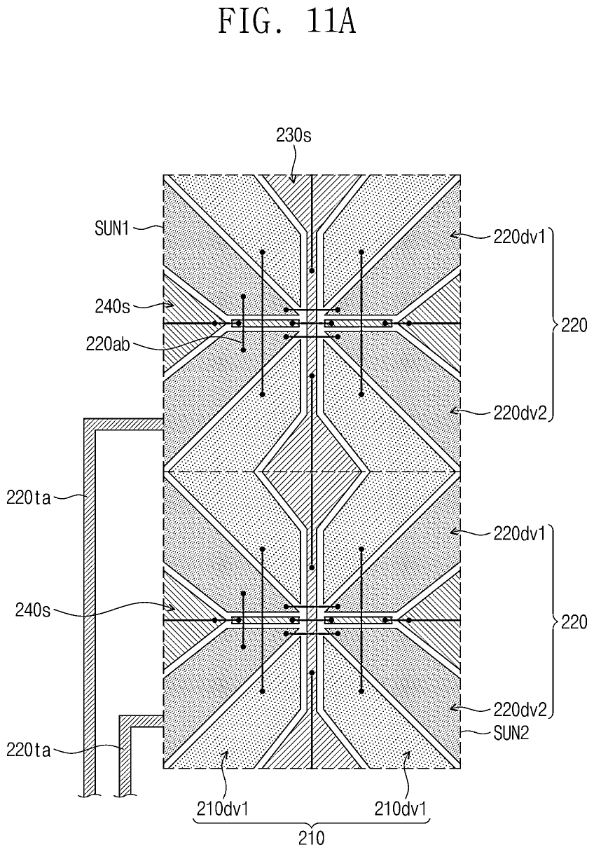

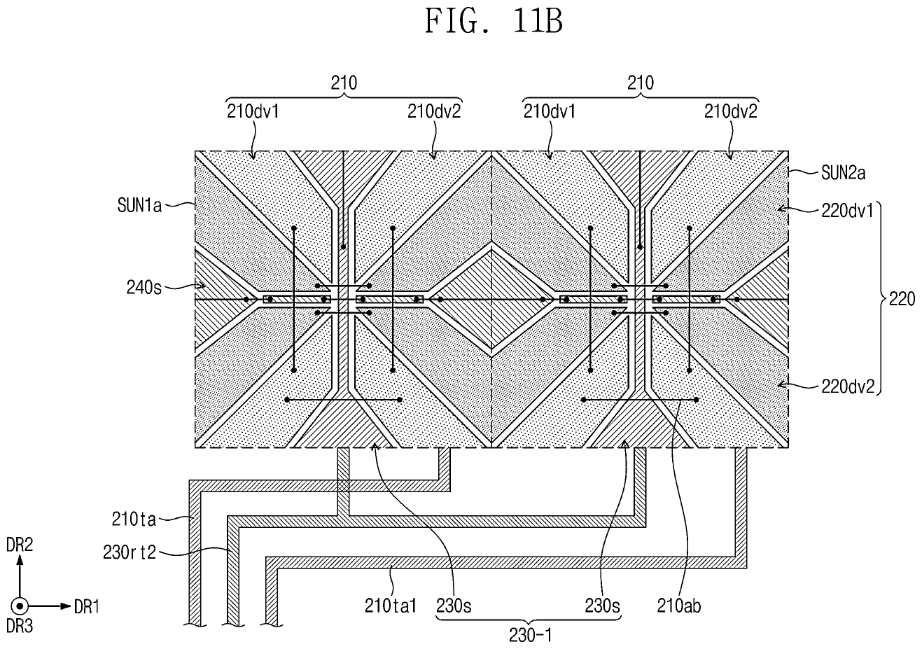

FIG. 11A is a cross-sectional view showing a portion of a sensor layer according to an embodiment of the present disclosure in an enlarged manner.

Referring to FIG. 11A, two sensing units SUN1 and SUN2 and two second trace lines 220ta are shown as an example. The second trace lines 220ta may be electrically connected to the second electrodes 220, respectively. In one embodiment of the present disclosure, the one second electrode 220 may be connected to the one second trace line 220ta via one connection point. In this case, each of the sensing units SUN1 and SUN2 may further include an additional bridge pattern 220ab for electrically connecting the two second split electrodes 220dv1 and 220dv2 included in the second electrode 220 to each other.

FIG. 11B is a cross-sectional view showing a portion of a sensor layer according to an embodiment of the present disclosure in an enlarged manner.

Referring to FIG. 11B, two sensing units SUN1a and SUN2a, two first trace lines 210ta and 210ta1, and one fifth trace line 230rt2 connected to one third electrode 230-1 are shown as an example. The fifth trace line 230rt2 may not overlap the first trace line 210ta1 and may overlap the first trace line 210ta. For example, a portion of the fifth trace line 230rt2 extending in the second direction DR2 may overlap the first trace line 210ta.

Each of the first trace lines 210ta and 210ta1 may be electrically connected to the first electrodes 210. In one embodiment of the present disclosure, the one first electrode 210 may be connected to the first trace line 210ta or 210ta1 via one connection point. In this case, each of the sensing units SUN1a and SUN2a may further include an additional bridge pattern 210ab for electrically connecting the two first split electrodes 210dv1 and 210dv2 included in the first electrode 210 to each other.

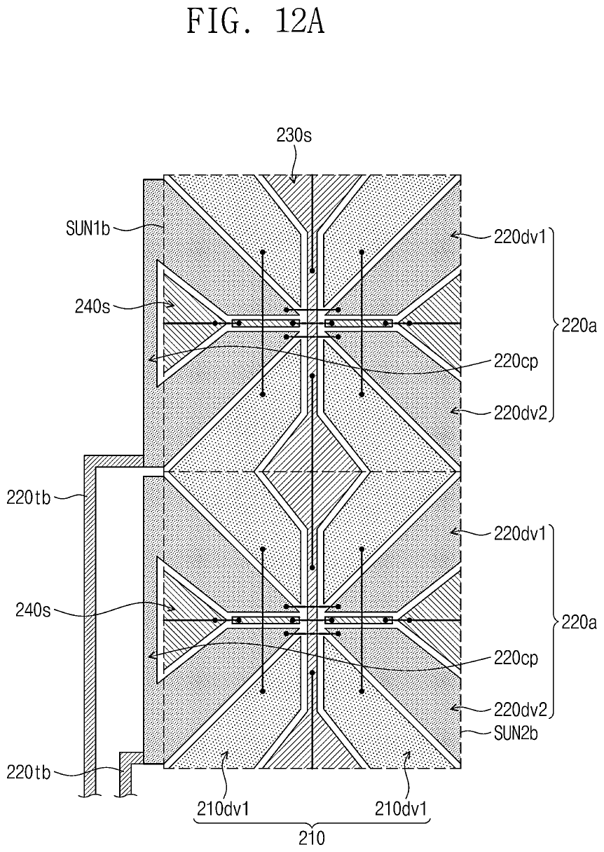

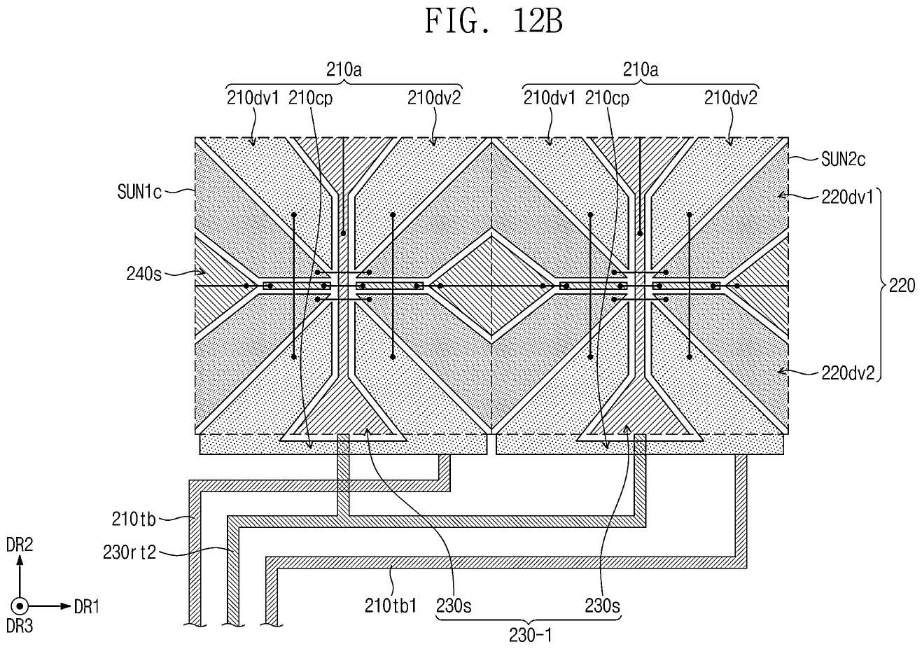

FIG. 12A is a cross-sectional view showing a portion of a sensor layer according to an embodiment of the present disclosure in an enlarged manner.

Referring to FIG. 12A, two sensing units SUN1b and SUN2b and two second trace lines 220tb are shown as an example.

The second trace lines 220tb may be electrically connected to second electrodes 220a. In one embodiment of the present disclosure, the one second electrode 220a may be connected to the one second trace line 220tb via one connection point. In this case, each of the second electrodes 220a may further include a connection portion 220cp connected to the two second split electrodes 220dv1 and 220dv2. The second trace line 220tb may be connected to the connection portion 220cp. The connection portion 220cp connected to the two second split electrodes 220dv1 and 220dv2 may form a triangle like shape.

FIG. 12B is a cross-sectional view showing a portion of a sensor layer according to an embodiment of the present disclosure in an enlarged manner.

Referring to FIG. 12B, two sensing units SUN1c and SUN2c, two first trace lines 210tb and 210tb1, and one fifth trace line 230rt2 are shown as an example. The fifth trace line 230rt2 may not overlap the first trace line 210tb1 and may overlap the first trace line 210tb.

The first trace lines 210tb and 210tb1 may be electrically connected to first electrodes 210a, respectively. In one embodiment of the present disclosure, the one first electrode 210a may be connected to the first trace line 210tb or 210tb1 via one connection point. In this case, the first electrode 210a may further include a connection portion 210cp connected to the two first split electrodes 210dv1 and 210dv2. The first trace line 210tb or 210tb1 may be connected to the connection portion 210cp. The connection portion 210cp may extend in the first direction DR1.

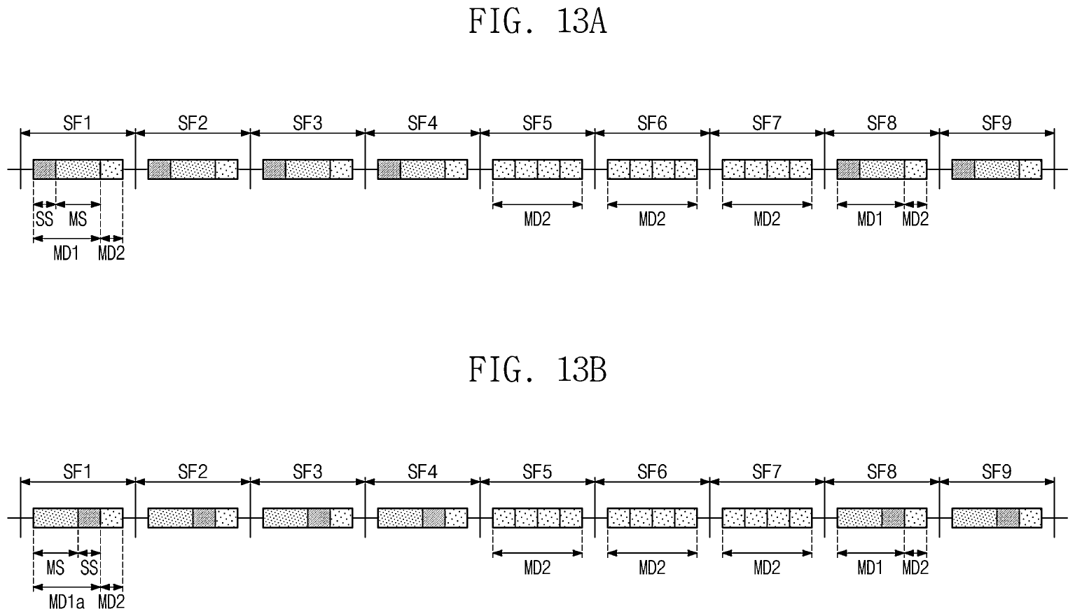

FIG. 13A is a diagram showing an operation of a sensor driver according to an embodiment of the present disclosure. FIG. 13B is a diagram showing an operation of a sensor driver according to an embodiment of the present disclosure. Each of FIGS. 13A and 13B shows operations in nine sensing frames SF1, SF2, SF3, SF4, SF5, SF6, SF7, SF8, and SF9 as an example.

Referring to FIGS. 4 and 13A, the sensor driver 200C may optionally operate in a first mode MD1 or a second mode MD2. The sensor layer 200 may be operated in the first mode MD1 or the second mode MD2 in response to an operation of the sensor driver 200C.

In each of the first to fourth sensing frames SF1, SF2, SF3, and SF4 and the eighth and ninth sensing frames SF8 and SF9, the sensor driver 200C may operate in a time-sharing manner in the first mode MD1 and the second mode MD2. FIGS. 13A and 13B show that the sensor driver 200C is continuously driven in the first mode MD1 and the second mode MD2, but the present disclosure is not particularly limited thereto. For example, the sensor driver 200C may operate in the second mode MD2 and then in the first mode MD1.

The first mode MD1 may include a self-capacitance detection mode SS and a mutual-capacitance detection mode MS. It is shown as an example in FIG. 13A that the sensor driver 200C is continuously driven in the self-capacitance detection mode SS and the mutual-capacitance detection mode MS, but the present disclosure is not particularly limited thereto. For example, as shown in FIG. 13B, the sensor driver 200C may operate in the mutual-capacitance detection mode MS and then in the self-capacitance detection mode SS in a first mode MD1a. In one embodiment of the present disclosure, the sensor driver 200C may be continuously driven in the self-capacitance detection mode SS, the second mode MD2, and the mutual-capacitance detection mode MS, or may be continuously driven in the mutual-capacitance detection mode MS, the second mode MD2, and the self-capacitance detection mode SS.

Each of the first to fourth sensing frames SF1, SF2, SF3, and SF4 and the eighth and ninth sensing frames SF8 and SF9 may be a touch sensing frame focusing on touch sensing. It is shown as an example in FIGS. 13A and 13B that each touch sensing frame includes the second mode MD2, but the present disclosure is not limited thereto. For example, an operating cycle in the second mode MD2 may be longer than an operating cycle in the first mode MD1.

The pen PN may be sensed in the second mode MD2 of the fourth sensing frame SF4. In this case, starting from a next frame, for example, from the fifth sensing frame SF5, the sensor driver 200C and the sensor layer 200 may continuously operate in the second mode MD2. The fifth, sixth, and seventh sensing frames SF5, SF6, and SF7 shown in FIGS. 13A and 13B may be pen sensing frames.

When the pen PN is not sensed during the continuous operation in the second mode MD2, the sensor driver 200C and the sensor layer 200 may operate in the time-sharing manner again in the first mode MD1 and the second mode MD2. For example, when the pen PN is not sensed in the seventh sensing frame SF7, the sensor driver 200C and the sensor layer 200 may operate in the time-sharing manner again in the first mode MD1 and the second mode MD2 from the eighth sensing frame SF8.

The above description has been made with the example in which the sensor driver 200C continuously operates in the second mode MD2 when the pen PN is sensed, but the present disclosure is not particularly limited thereto. For example, the sensor driver 200C may operate continuously in the second mode MD2 by user selection, execution of a specific application, or the occurrence of a specific operation (e.g., pen removal). In addition, the above description has been made with the example in which the sensor driver 200C operates in the time-sharing manner in the first mode MD1 and the second mode MD2 when the pen PN is not sensed, but the present disclosure is not particularly limited thereto. For example, the sensor driver 200C may operate in the time-sharing manner in the first mode MD1 and the second mode MD2 by user selection, execution or termination of a specific application, or the occurrence of a specific operation (e.g., pen coupling).

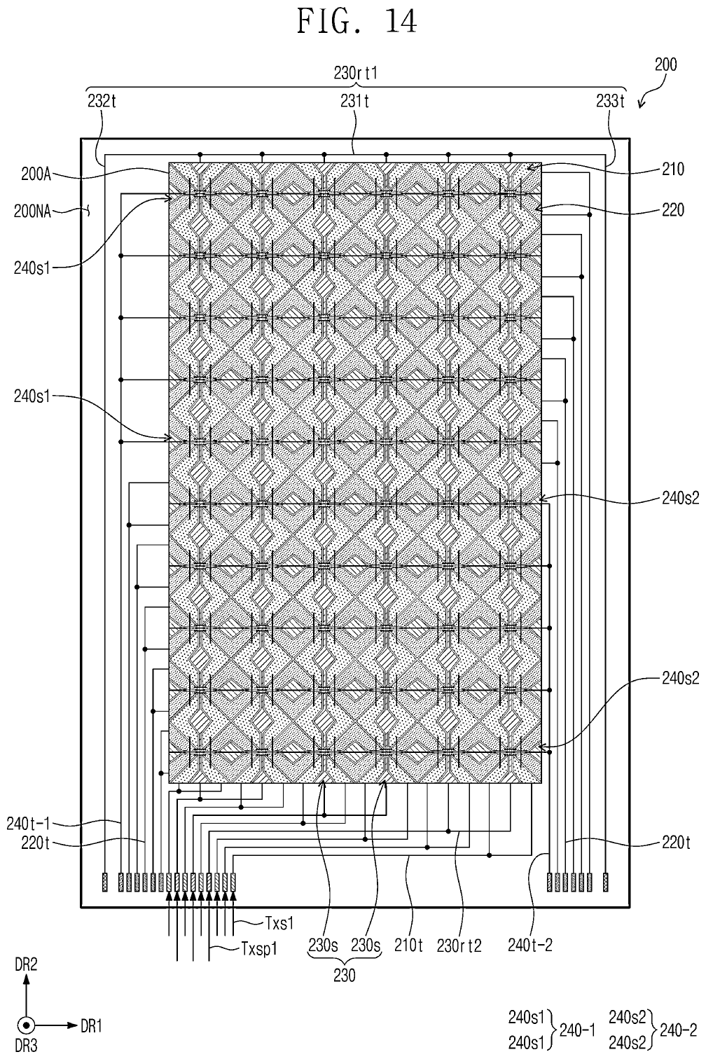

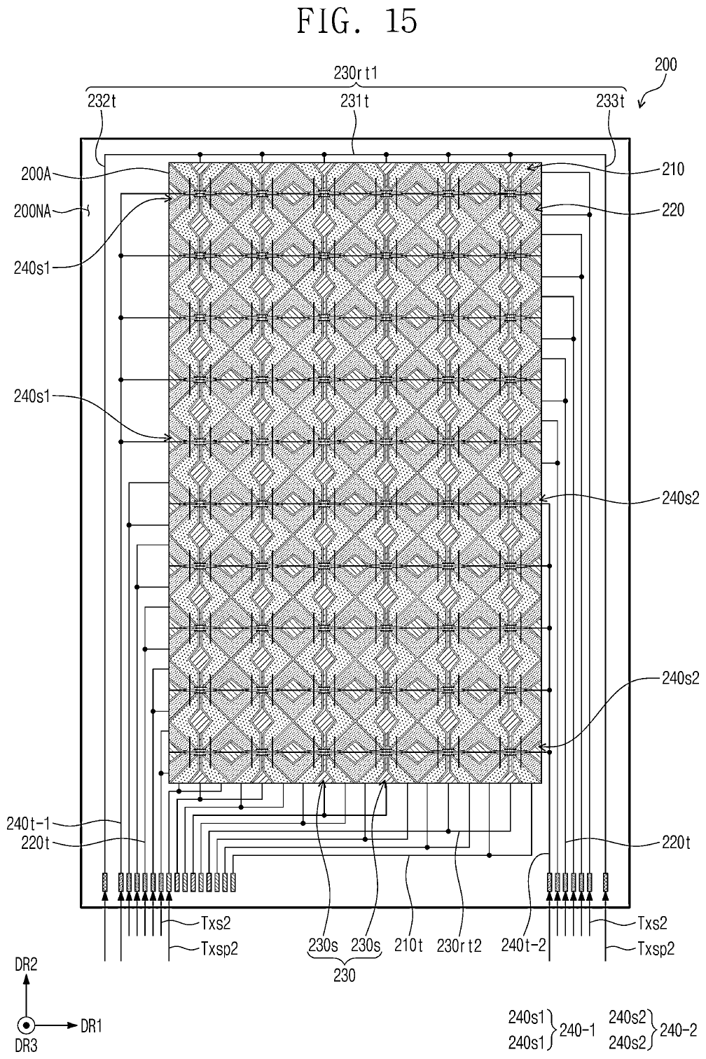

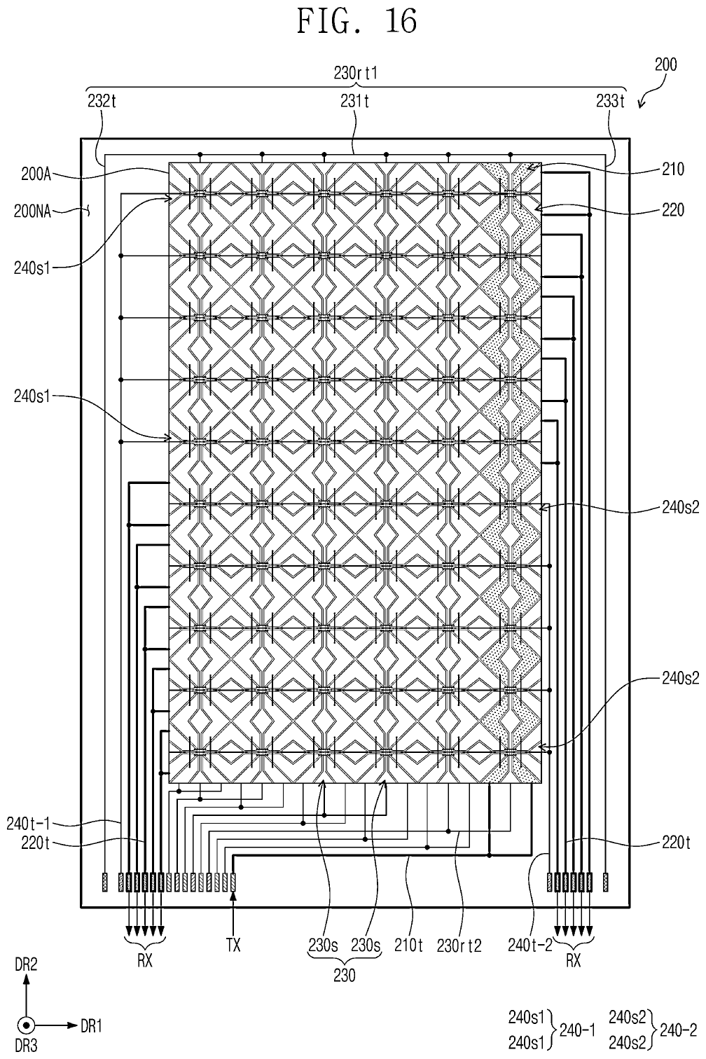

FIG. 14 is a diagram for illustrating a first mode according to an embodiment of the present disclosure. FIG. 15 is a diagram for illustrating a first mode according to an embodiment of the present disclosure.

Referring to FIGS. 4, 13A, 14, and 15, the first mode MD1 includes the self-capacitance detection mode SS. The self-capacitance detection mode SS may include a first sub-section and a second sub-section. FIG. 14 is a diagram for illustrating an operation in the first sub-section, and FIG. 15 is a diagram for illustrating an operation in the second sub-section. The first sub-section may be referred to as a first time period, and the second sub-section may be referred to as a second time period.

The sensor driver 200C may output driving signals Txs1 and Txs2 to the first electrodes 210 and the second electrodes 220 in the self-capacitance detection mode SS, and may calculate input coordinates by sensing a change in a capacitance of each of the first electrodes 210 and the second electrodes 220.

In one embodiment of the present disclosure, the sensor driver 200C may output a driving signal Txsp1 or Txsp2 to at least some of the third trace line 230rt1, the fourth trace lines 240t-1 and 240t-2, and the fifth trace lines 230rt2 in a partial section of the first mode MD1. For example, the partial section of the first mode MD1 may correspond to the self-capacitance detection mode SS. As an example, the first mode MD1 corresponds to a portion of the first sensing frame SF1, and the partial section of the first mode MD1 may be less than the entire time the first mode MD1 is operated in the first sensing frame SF1.

In other words, the same signal as a signal provided to the adjacent first trace lines 210t or second trace lines 220t may be provided to at least some of the third trace line 230rt1, the fourth trace lines 240t-1 and 240t-2, and the fifth trace lines 230rt2. In this case, at least some of the third trace line 230rt1, the fourth trace lines 240t-1 and 240t-2, and the fifth trace lines 230rt2 may operate as guard lines.

Referring to FIG. 14, in the first sub-section, the sensor driver 200C may output the driving signal Txs1 to the first trace lines 210t. In this case, the sensor driver 200C may also output the driving signal Txsp1 to the fifth trace lines 230rt2, which are disposed adjacent to the first trace lines 210t. The driving signal Txs1 and the driving signal Txsp1 are signals having the same waveform, and are substantially the same signal. In this case, a parasitic capacitance may not be generated between the first trace lines 210t and the fifth trace lines 230rt2.

Referring to FIG. 15, in the second sub-section, the sensor driver 200C may output the driving signal Txs2 to the second trace lines 220t. In this case, the sensor driver 200C may output the driving signal Txsp2 to the third trace line 230rt1 and the fourth trace lines 240t-1 and 240t-2, which are disposed adjacent to the second trace lines 220t. The driving signal Txs2 and the driving signal Txsp2 are signals having the same waveform, and are substantially the same signal. In this case, a parasitic capacitance may not be generated between the second trace lines 220t, the third trace line 230rt1, and the fourth trace lines 240t-1 and 240t-2.

In one embodiment of the present disclosure, the third electrodes 230 are electrically connected to the third trace line 230rt1 and the fifth trace line 230rt2, and the plurality of fourth electrodes 240-1 and 240-2 are electrically connected to the fourth trace lines 240t-1 and 240t-2. Therefore, when the sensor driver 200C outputs the driving signal Txsp1 or Txsp2 to at least some of the third trace line 230rt1, the fourth trace lines 240t-1 and 240t-2, and the fifth trace lines 230rt2, the driving signal Txsp1 or Txsp2 may also be transmitted to the third electrodes 230 and the plurality of fourth electrodes 240-1 and 240-2.

According to one embodiment of the present disclosure, in the self-capacitance detection mode SS, the same signal as the signal provided to the first electrodes 210 and the second electrodes 220 may be provided to at least some of the trace lines connected to the third electrodes 230 and the plurality of fourth electrodes 240-1 and 240-2. Accordingly, a parasitic capacitance generated between the trace lines may be reduced or eliminated. As a result, touch sensitivity may be improved in the self-capacitance detection mode SS.

Additionally, because at least some of the third trace lines 230rt1, the fourth trace lines 240t-1 and 240t-2, and the fifth trace lines 230rt2 operate as the guard lines, there is no need to add a separate guard line. Therefore, there is no need to allocate a space for the separate guard line, as well as for a pad connected to the separate guard line. Therefore, a degree of design freedom may be improved.

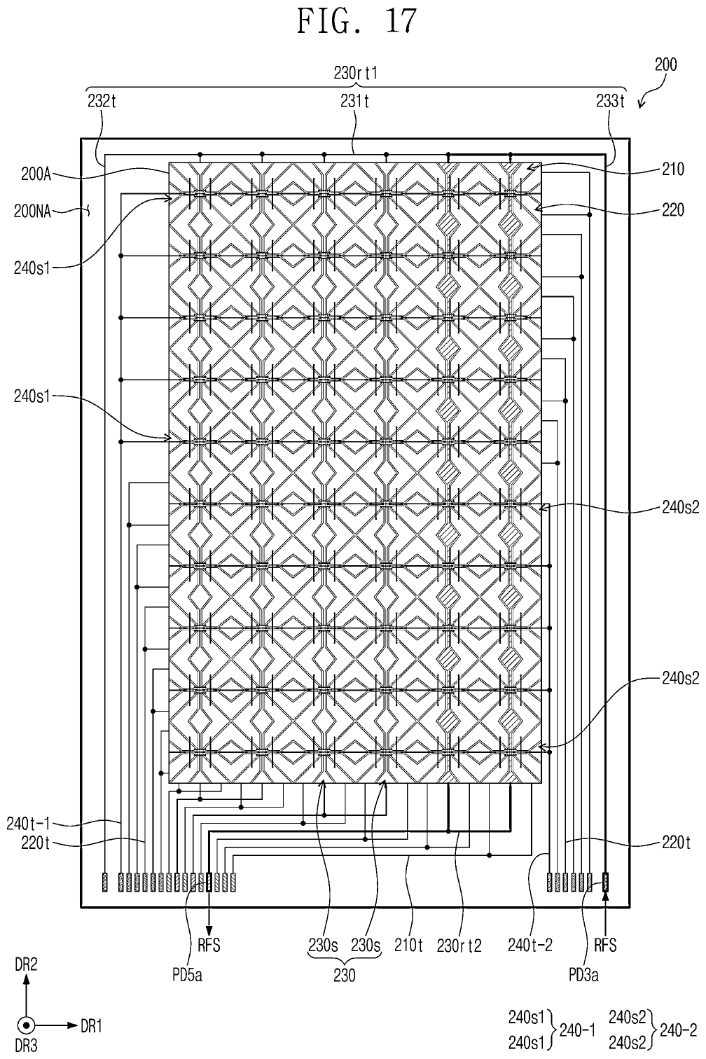

FIG. 16 is a diagram for illustrating a first mode according to an embodiment of the present disclosure.

Referring to FIGS. 4, 13A, and 16, the first mode MD1 includes the mutual-capacitance detection mode MS. FIG. 16 is a diagram for illustrating the mutual-capacitance detection mode MS in the first mode MD1.

In the mutual-capacitance detection mode MS, the sensor driver 200C may sequentially provide a transmission signal TX to the first electrodes 210, and detect coordinates for the first input 2000 using a reception signal RX detected via the second electrodes 220. For example, the sensor driver 200C may calculate input coordinates by sensing a change in mutual capacitance between the first electrodes 210 and the second electrodes 220.

It is represented as an example in FIG. 16 that the transmission signal TX is provided to the one first electrode 210 and the reception signal RX is output from the second electrodes 220. To facilitate understanding, only the first electrode 210 to which the transmission signal TX is provided is hatched in FIG. 16 (this is on the right side of FIG. 16). The sensor driver 200C may detect the input coordinates for the first input 2000 by sensing the change in the capacitance between the first electrode 210 and the second electrodes 220.

In the mutual-capacitance detection mode MS, the third electrodes 230 and the plurality of fourth electrodes 240-1 and 240-2 may be grounded, applied with a constant voltage, or electrically floating.

FIG. 17 is a diagram for illustrating a second mode according to an embodiment of the present disclosure.

Referring to FIGS. 4, 6, 13A, and 17, the second mode MD2 may include a charging section and a pen sensing section. FIG. 17 is a diagram for illustrating a charging section.

In one embodiment of the present disclosure, in the charging section, the sensor driver 200C may apply a first signal to one of the third pads PD3 and the fifth pads PD5, and apply a second signal to another pad. The second signal may be an inverse signal of the first signal. For example, the first signal may be a signal with a pulse waveform or a signal with a sine waveform. Accordingly, a current RFS may have a path of a current flowing from one pad to another pad. Additionally, because the first signal and the second signal have pulse waveforms or sine waveforms that are in antiphase to each other, a direction of the current RFS may change periodically. Additionally, because the second signal is in antiphase to the first signal, noise caused by the first signal and noise caused by the second signal may cancel each other. Therefore, flicker may not occur in the display layer 100 (see FIG. 3).

In one embodiment of the present disclosure, in the charging section, the sensor driver 200C may apply the first signal to one of the third pads PD3 and the fifth pads PD5, and another pad may be grounded. In this case as well, the current RFS may flow from the one pad to the another pad. Additionally, even when the another pad is grounded, the direction of the current RFS may change periodically because the first signal has the pulse wave or the sine wave.

The one pad to which the first signal is applied and the another pad to which the second signal is applied or that is grounded may be continuously changed. Therefore, loop coil patterns in various locations and shapes may form a magnetic field.

In FIG. 17, a case in which the current RFS is provided to one third pad PD3a connected to the one third trace line 230rt1 and the current RFS is received via one fifth pad PD5a connected to the third electrode 230 is shown as an example. In this case, a coil-shaped current path may be formed by a portion of the third trace line 230rt1 connected to the third pad PD3a, a portion of the fifth trace line 230rt2 connected to the fifth pad PD5a, and the third electrode 230 connected to the fifth trace line 230rt2. In the second mode, a resonant circuit of the pen PN may be charged by the current path.

According to the present disclosure, a current path of the loop coil pattern may be implemented by the components included in the sensor layer 200. The electronic device 1000 (see FIG. 1) may sense the input by the pen PN even when a digitizer is not included. Therefore, because there is no need to add the digitizer for sensing the pen PN, an increase in thickness, an increase in weight, and a decrease in flexibility of the electronic device 1000 due to the addition of the digitizer may not occur.

In the charging section, the first electrodes 210, the second electrodes 220, and the plurality of fourth electrodes 240-1 and 240-2 may be grounded, applied with a constant voltage, or electrically floating. In particular, the first electrodes 210, the second electrodes 220, and the plurality of fourth electrodes 240-1 and 240-2 may be floating. In this case, the current RFS may not flow to the first electrodes 210, the second electrodes 220, and the plurality of fourth electrodes 240-1 and 240-2.

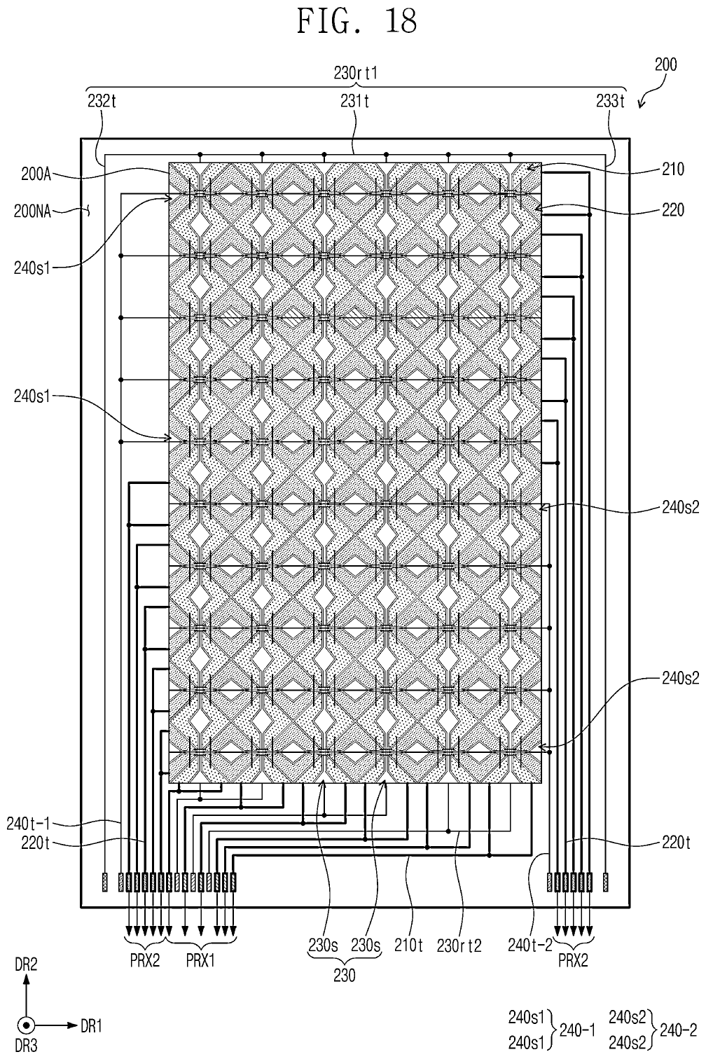

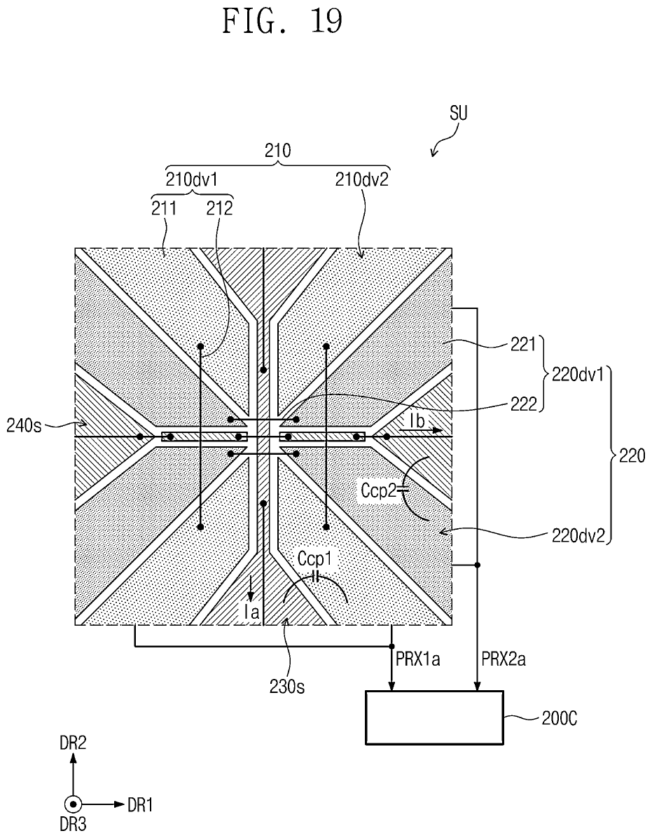

FIG. 18 is a diagram for illustrating a second mode according to an embodiment of the present disclosure. FIG. 19 is a diagram for illustrating a second mode according to an embodiment of the present disclosure.

Referring to FIGS. 4, 13A, 18, and 19, the second mode may include the charging section and the pen sensing section. FIGS. 18 and 19 are diagrams for illustrating a pen sensing section. FIG. 19 shows the one sensing unit SU through which first and second induced currents Ia and Ib generated by the pen PN flow.

The sensor driver 200C may receive a first reception signal PRX1 from the first electrodes 210 and a second reception signal PRX2 from the second electrodes 220. In this regard, the third electrodes 230 and the plurality of fourth electrodes 240-1 and 240-2 may be floating, grounded, or applied with the constant voltage.

The LC resonance circuit of the pen PN may emit the magnetic field at the resonant frequency while discharging charged charges. The first induced current Ia may be generated in the first sub-electrode 230s of the third electrode 230 by the magnetic field provided from the pen PN, and the second induced current Ib may be generated in the second sub-electrode 240s of the fourth electrode 240-1 or 240-2. A first coupling capacitor Ccp1 may be formed between the third electrode 230 and the first electrode 210, and a second coupling capacitor Ccp2 may be formed between the fourth electrode 240-1 or 240-2 and the second electrode 220. The first induced current Ia may be transmitted from the third electrode 230 to the first electrode 210 via the first coupling capacitor Ccp1, and the second induced current Ib may be transmitted from the fourth electrode 240-1 or 240-2 to the second electrode 220 via the second coupling capacitor Ccp2.

The sensor driver 200C may receive a first reception signal PRX1a based on the first induced current Ia from the first electrode 210 and receive a second reception signal PRX2a based on the second induced current Ib from the second electrode 220. The sensor driver 200C may detect the input coordinates of the pen PN based on the first reception signal PRX1a and the second reception signal PRX2a.

In the pen sensing section, the third electrodes 230 and the plurality of fourth electrodes 240-1 and 240-2 may be grounded or applied with the constant voltage. The sensor driver 200C may detect the coordinates for the pen input based on the current provided from the first electrodes 210 and the second electrodes 220.

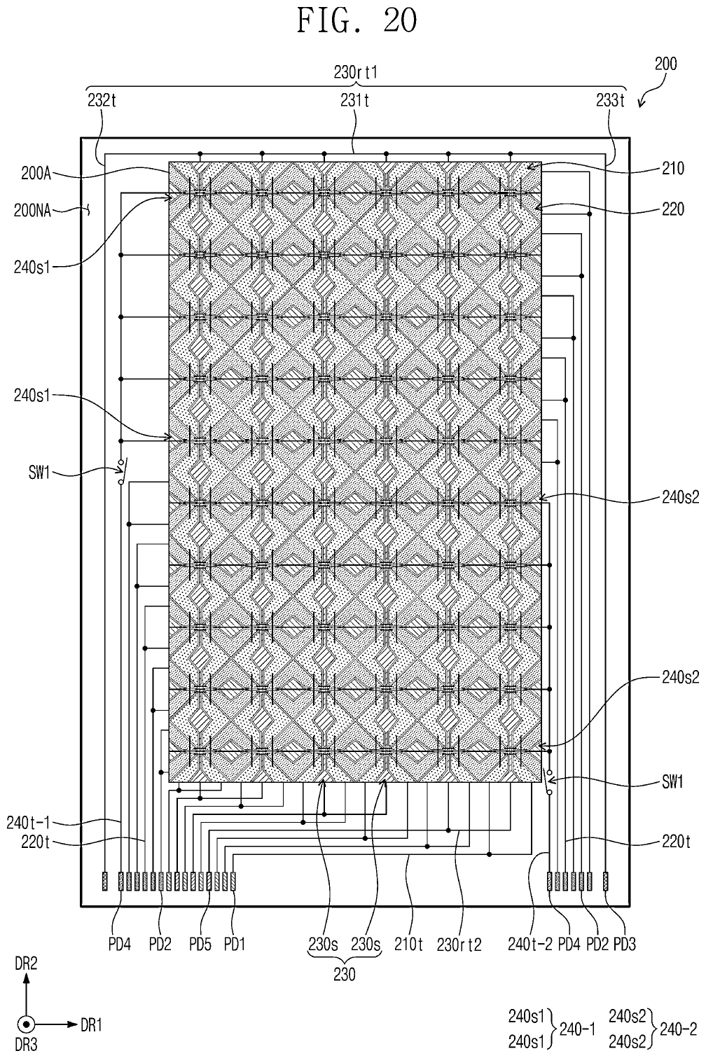

FIG. 20 is a plan view of the sensor layer 200 according to an embodiment of the present disclosure.

Referring to FIG. 20, a switch SW1 may be disposed between each of the plurality of fourth electrodes 240-1 and 240-2 and each of the fourth trace lines 240t-1 and 240t-2. The switch SW1 may be turned on or off depending on an operation mode of the sensor layer 200.

In one embodiment of the present disclosure, the switch SW1 may be a transistor. The switch SW1 may be included in the sensor layer 200 or in the display layer 100 (see FIG. 5). For example, when the switch SW1 is included in the display layer 100, the transistor constituting the switch SW1 may have a stacked structure similar to that of the transistor 100PC shown in FIG. 5, and may be formed simultaneously via the same process as the transistor 100PC. However, this is only an example and the present disclosure is not particularly limited thereto.

In one embodiment of the present disclosure, as described in FIGS. 14 and 15, when the driving signal Txsp1 or Txsp2 is provided to at least some of the third trace line 230rt1, the fourth trace lines 240t-1 and 240t-2, and the fifth trace lines 230rt2, the switch SW1 may be turned off. For example, the plurality of fourth electrodes 240-1 and 240-2 may be electrically separated from the fourth trace lines 240t-1 and 240t-2. In this case, the driving signal Txsp1 or Txsp2 may not be provided to the plurality of fourth electrodes 240-1 and 240-2.

The switch SW1 may be turned off in the first mode MD1 and turned on in the second mode MD2. When the switch SW1 is turned off, the plurality of fourth electrodes 240-1 and 240-2 may be electrically separated from the fourth trace lines 240t-1 and 240t-2. Accordingly, this approach may result in the effect of reducing the area size of the electrode that is electrically connected and responsible for generating the capacitance. For example, in the state in which the switch SW1 is turned on, the one fourth electrode 240-1 and the one fourth trace line 240t-1 may be connected to each other to constitute an area size of one electrode. In the state in which the switch SW1 is turned off, the one fourth electrode 240-1 and the one fourth trace line 240t-1 may be electrically separated from each other to constitute area sizes of respective electrodes. Accordingly, the area size may be reduced, and thus, a base capacitance may be reduced.

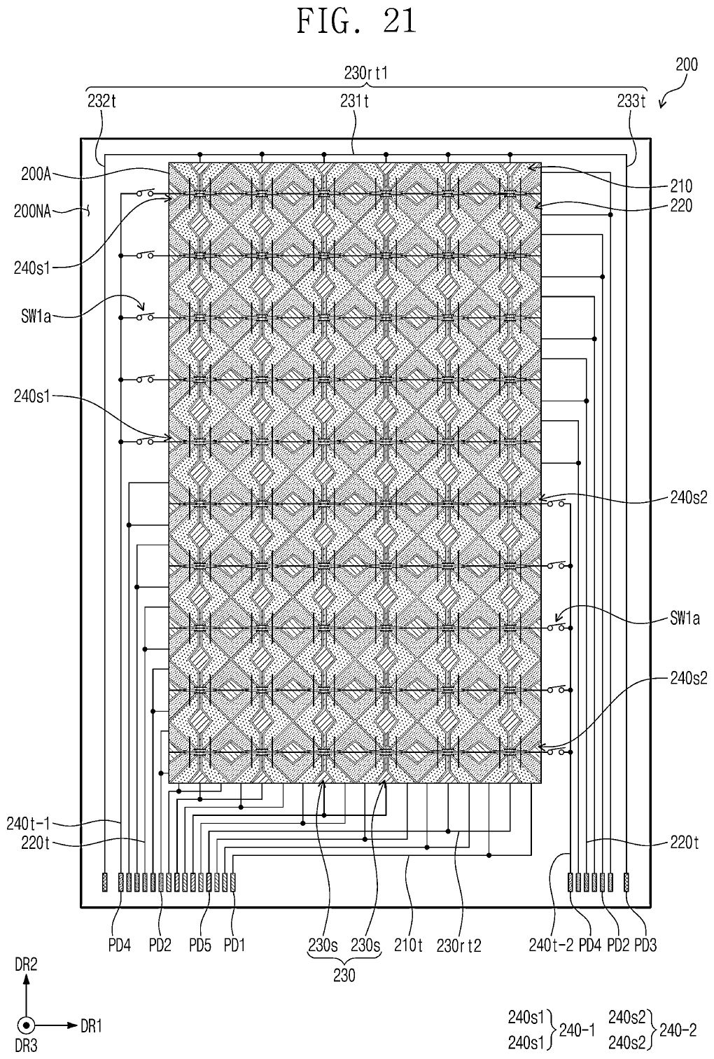

FIG. 21 is a plan view of the sensor layer 200 according to an embodiment of the present disclosure.

Referring to FIG. 21, a plurality of switches SW1a may be disposed between the plurality of fourth electrodes 240-1 and 240-2 and the fourth trace lines 240t-1 and 240t-2. The switches SW1a may be connected in one-to-one correspondence to the second sub-electrodes 240s1 and 240s2, respectively. The plurality of switches SW1a may be turned on or off depending on the operation mode of the sensor layer 200. The switches SW1a may be turned off in the first mode MD1 and turned on in the second mode MD2.

As described in FIGS. 14 and 15, when the driving signal Txsp1 or Txsp2 is provided to at least some of the third trace line 230rt1, the fourth trace lines 240t-1 and 240t-2, and the fifth trace lines 230rt2, the switches SW1a may be turned off. For example, the second sub-electrodes 240s1 and 240s2 may be electrically separated from the fourth trace lines 240t-1 and 240t-2. In this case, the driving signal Txsp1 or Txsp2 may not be provided to the second sub-electrodes 240s1 and 240s2.

In addition, when the switches SW1a are turned off, not only are the second sub-electrodes 240s1 and 240s2 electrically separated from the fourth trace lines 240t-1 and 240t-2, but the second sub-electrodes 240s1 and 240s2 are also electrically separated from each other. In other words, the area size of the one electrode unit that generates the capacitance may be reduced, and thus, the base capacitance may be reduced.

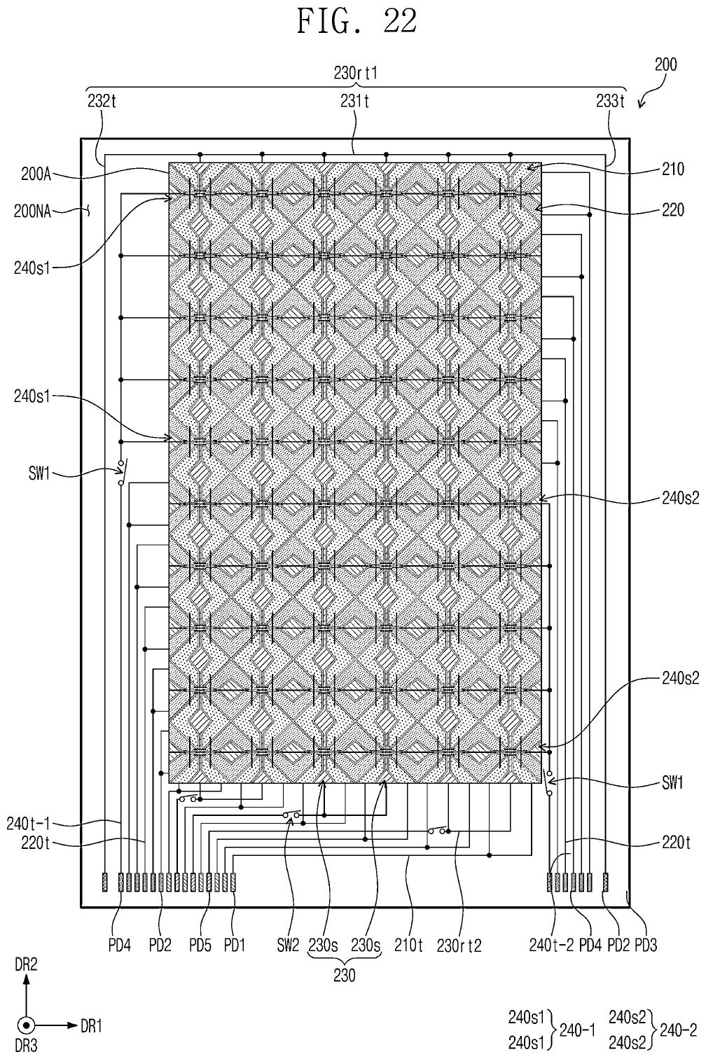

FIG. 22 is a plan view of the sensor layer 200 according to an embodiment of the present disclosure.

Referring to FIG. 22, the switch (hereinafter, referred to as a first switch) SW1 may be disposed between each of the plurality of fourth electrodes 240-1 and 240-2 and each of the fourth trace lines 240t-1 and 240t-2, respectively, and a switch (hereinafter, referred to as a second switch) SW2 may be disposed between each of the third electrodes 230 and each of the fifth trace lines 230rt2. The first switch SW1 and the second switch SW2 may be turned on or off depending on the operation mode of the sensor layer 200. For example, the first switch SW1 and the second switch SW2 may be turned off in the first mode MD1 and the first switch SW1 and the second switch SW2 may be turned on in the second mode MD2.

As described in FIGS. 14 and 15, when the driving signal Txsp1 or Txsp2 is provided to at least some of the third trace line 230rt1, the fourth trace lines 240t-1 and 240t-2, and the fifth trace lines 230rt2, the first switch SW1 and the second switch SW2 may be turned off.

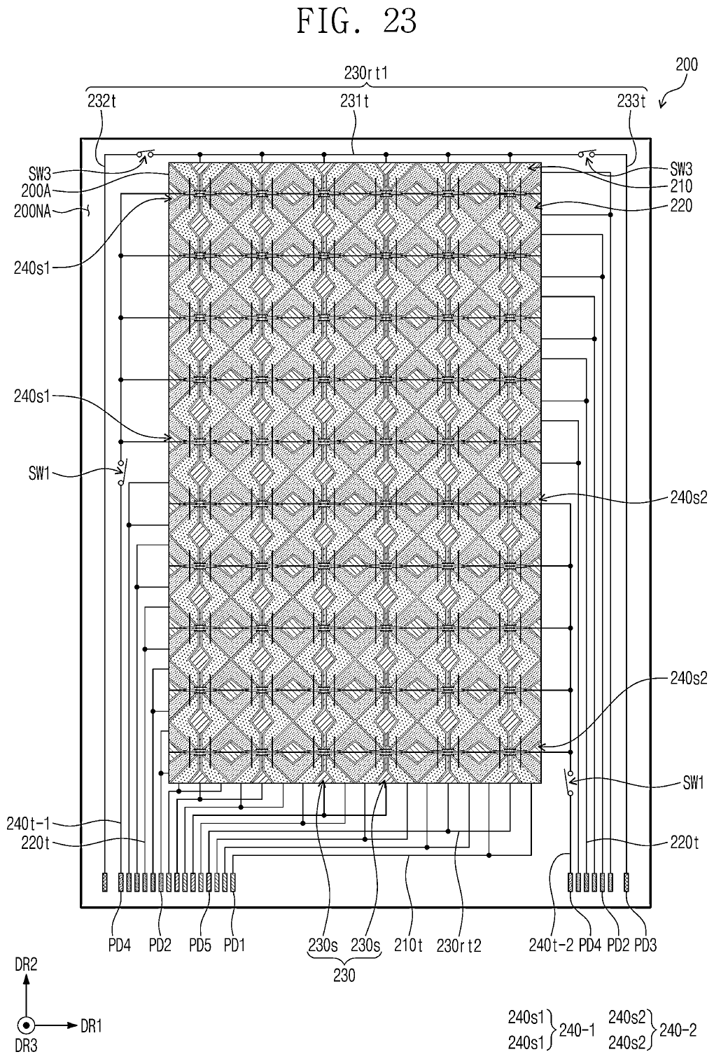

FIG. 23 is a plan view of the sensor layer 200 according to an embodiment of the present disclosure.

Referring to FIG. 23, the switch SW1 (hereinafter, referred to as the first switch) may be disposed between each of the plurality of fourth electrodes 240-1 and 240-2 and each of the fourth trace lines 240t-1 and 240t-2, and switches (hereinafter, referred to as third switches) SW3 may be disposed between the first line portion 231t and the second line portion 232t and between the first line portion 231t and the third line portion 233t, respectively. The first switch SW1 and the third switch SW3 may be turned on or off depending on the operation mode of the sensor layer 200. For example, the first switch SW1 and the third switch SW3 may be turned off in the first mode MD1 and the first switch SW1 and the third switch SW3 may be turned on in the second mode MD2.

As described in FIGS. 14 and 15, when the driving signal Txsp1 or Txsp2 is provided to at least some of the third trace line 230rt1, the fourth trace lines 240t-1 and 240t-2, and the fifth trace lines 230rt2, the first switch SW1 and the third switch SW3 may be turned off.

According to the above-described embodiments, in the self-capacitance detection mode, the same signal as the signal provided to the first electrodes and the second electrodes may be provided to at least some of the trace lines connected to the third electrodes and the plurality of fourth electrodes. Accordingly, the parasitic capacitance generated between the trace lines may be reduced or eliminated. As a result, the touch sensitivity may be improved in the self-capacitance detection mode. Additionally, because at least some of the trace lines connected to the third electrodes and the plurality of fourth electrodes operate as the guard lines, there is no need to add the separate guard line. Therefore, there is no need to allocate space for both the separate guard line and the pad connected to the separate guard line. Therefore, the degree of design freedom may be improved.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a sensor layer; and
a sensor driver configured to operate the sensor layer, wherein the sensor driver is further configured to operate in a first mode for sensing a touch input or in a second mode for sensing a pen input,
wherein the sensor layer includes:
a plurality of first electrodes arranged along a first direction and extending along a second direction intersecting the first direction;
a plurality of second electrodes arranged along the second direction and extending along the first direction;
a plurality of third electrodes arranged along the first direction and extending along the second direction;
a fourth electrode arranged along the second direction, extending along the first direction, and including a plurality of sub-electrodes electrically connected with each other;
a plurality of first trace lines electrically connected to the plurality of first electrodes, respectively;
a plurality of second trace lines electrically connected to the plurality of second electrodes, respectively;
a third trace line electrically connected to the plurality of third electrodes; and
a fourth trace line electrically connected to the fourth electrode and connected to an end of each of the plurality of sub-electrodes,
wherein the sensor driver is configured to output a driving signal to the third trace line and the fourth trace line in the first mode.

2. The electronic device of claim 1, wherein the first mode includes a mutual-capacitance detection mode and a self-capacitance detection mode,
wherein the sensor driver is configured to output the driving signal to the plurality of first electrodes and the plurality of second electrodes in the self-capacitance detection mode.

3. The electronic device of claim 2, wherein the self-capacitance detection mode includes a first time period and a second time period,
wherein the sensor driver is configured to:
output the driving signal to the plurality of first trace lines in the first time period; and
output the driving signal to the plurality of second trace lines, the third trace line, and the fourth trace line in the second time period.

4. The electronic device of claim 2, wherein the plurality of third electrodes and the fourth electrode are grounded in the mutual-capacitance detection mode.

5. The electronic device of claim 2, wherein the driving signal is provided to the plurality of third electrodes and the fourth electrode in the self-capacitance detection mode.

6. The electronic device of claim 2, wherein the plurality of third electrodes and the fourth electrode are electrically separated from the plurality of third trace lines and the fourth trace line in the self-capacitance detection mode.

7. The electronic device of claim 1, further comprising:
a switch connected between the fourth electrode and the fourth trace line, wherein the switch is turned off in the first mode and is turned on in the second mode.

8. The electronic device of claim 1, further comprising:
a plurality of switches connected between the plurality of sub-electrodes, wherein the plurality of switches are turned off in the first mode and are turned on in the second mode.

9. The electronic device of claim 1, wherein the third trace line includes a first portion extending along the first direction and electrically connected to the plurality of third electrodes, a second portion extending along the second direction from a first end of the first portion, and a third portion extending along the second direction from a second end of the first portion.

10. The electronic device of claim 9, further comprising:
a plurality of switches connected between the first portion and the second portion and between the first portion and the third portion, respectively, wherein the plurality of switches are turned off in the first mode and turned on in the second mode.

11. The electronic device of claim 1, wherein the sensor layer further includes a plurality of fifth trace lines electrically connected to the plurality of third electrodes, respectively.

12. The electronic device of claim 11, further comprising:
a plurality of switches connected between the plurality of fifth trace lines and the plurality of third electrodes, respectively, wherein the plurality of switches are turned off in the first mode and are turned on in the second mode.

13. The electronic device of claim 1, wherein the second mode includes a charging section and a pen sensing section,
wherein the plurality of first electrodes, the plurality of second electrodes, and the fourth electrode are grounded in the charging section,
wherein, in the pen sensing section, the plurality of third electrodes and the fourth electrode are grounded, and the sensor driver is configured to detect coordinates for the pen input based on a current provided from the plurality of first electrodes and the plurality of second electrodes.

14. An electronic device comprising:
a sensor layer including a plurality of first electrodes, a plurality of second electrodes, a plurality of third electrodes, a fourth electrode, and a plurality of trace lines; and
a sensor driver configured to operate the sensor layer, wherein the sensor driver is further configured to operate in a mutual-capacitance detection mode, a self-capacitance detection mode, or a pen sensing mode including a charging time period and a pen sensing time period,
wherein the sensor driver is configured to, in the self-capacitance detection mode, output a driving signal to the plurality of first electrodes and the plurality of second electrodes, and calculate input coordinates by sensing a change in capacitance of each of the plurality of first electrodes and the plurality of second electrodes,
wherein the sensor driver is configured to output the driving signal to at least some of the trace lines connected to the plurality of third electrodes and the fourth electrode in the self-capacitance detection mode.

15. The electronic device of claim 14, wherein the fourth electrode includes a plurality of sub-electrodes electrically connected each other,
wherein the plurality of trace lines include:
a plurality of first trace lines electrically connected to the plurality of first electrodes, respectively;
a plurality of second trace lines electrically connected to the plurality of second electrodes, respectively;
a third trace line connected to a first end of each of the plurality of third electrodes;
a fourth trace line electrically connected to the fourth electrode and connected to an end of each of the plurality of sub-electrodes; and
a plurality of fifth trace lines connected to second ends of the plurality of third electrodes, respectively,
wherein the sensor driver is configured to output the driving signal to the third trace line and the fourth trace line in the self-capacitance detection mode.

16. The electronic device of claim 15, wherein the driving signal is provided to the plurality of third electrodes and the fourth electrode in the self-capacitance detection mode.

17. The electronic device of claim 15, wherein the plurality of third electrodes and the fourth electrode are electrically separated from the plurality of third trace lines and the fourth trace line in the self-capacitance detection mode.

18. The electronic device of claim 15, wherein the sensor driver is configured to, in the charging section, apply a current to one of a plurality of pads connected to the third trace line and the plurality of fifth trace lines and to receive current via another pad, and wherein the plurality of first electrodes, the plurality of second electrodes, and the fourth electrode are grounded in the charging section,
wherein the sensor driver is configured to detect coordinates for a pen input based on a current provided from the plurality of first electrodes and the plurality of second electrodes in the pen sensing section, and wherein the plurality of third electrodes and the fourth electrode are grounded in the pen sensing section.

19. The electronic device of claim 14, wherein the sensor driver is configured to, in the mutual-capacitance detection mode, output a transmission signal to the plurality of first electrodes, receive a reception signal from the plurality of second electrodes, and calculate input coordinates by sensing a change in mutual capacitance between the plurality of first electrodes and the plurality of second electrodes,
wherein the plurality of third electrodes and the fourth electrode are grounded in the mutual-capacitance detection mode.

20. An electronic device comprising:
a sensor layer including a plurality of first electrodes arranged along a first direction and extending along a second direction intersecting the first direction, a plurality of second electrodes arranged along the second direction and extending along the first direction, a plurality of third electrodes arranged along the first direction and extending along the second direction, a fourth electrode arranged along the second direction, extending along the first direction, and including a plurality of sub-electrodes connected in parallel with each other, a plurality of first trace lines electrically connected to the plurality of first electrodes, respectively, a plurality of second trace lines electrically connected to the plurality of second electrodes, respectively, a third trace line electrically connected to a first end of each of the plurality of third electrodes, a fourth trace line electrically connected to the fourth electrode and connected to the end of each of the plurality of sub-electrodes, and a plurality of fifth trace lines connected to second ends of the plurality of third electrodes, respectively; and
a sensor driver configured to drive the sensor layer, and operate in a pen sensing mode for sensing a pen input or in a touch sensing mode for sensing a touch input,
wherein, in the pen sensing mode, the sensor driver is configured to apply a current to one of a plurality of pads connected to the third trace line and the plurality of fifth trace lines, receive current via another pad, and detect coordinates for the pen input based on a current provided from the plurality of first electrodes and the plurality of second electrodes,
wherein the sensor driver is configured to output a driving signal to the plurality of first electrodes and the plurality of second electrodes in the touch sensing mode, and calculate input coordinates by sensing a change in capacitance of each of the plurality of first electrodes and the plurality of second electrodes,
wherein the sensor driver is configured to output the driving signal to the plurality of first electrodes and the plurality of second electrodes in the touch sensing mode, calculate input coordinates by sensing a change in capacitance of each of the plurality of first electrodes and the plurality of second electrodes, and output the driving signal to at least some of the third trace line, the fourth trace line, and the plurality of fifth trace lines in the touch sensing mode.

21. The electronic device of claim 20, wherein the driving signal is provided to the plurality of third electrodes and the fourth electrode in the touch sensing mode.

22. The electronic device of claim 20, wherein the plurality of third electrodes and the fourth electrode are electrically separated from at least some of the plurality of third trace lines, the fourth trace line, and the plurality of fifth trace lines in the touch sensing mode, and are not provided with the driving signal.
